(19) United States
(12) Patent Application Publication
(10) Pub. No.: US 2009/0149348 A1
(43) Pub. Date: Jun. 11, 2009

(54) NUCLEIC ACID LIBRARIES AND PROTEIN STRUCTURES

(76) Inventors: James Drummond, Bloomington, IN (US); Daniel Maillet, Bloomington, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/184,993

(22) Filed: Aug. 1, 2008

Related U.S. Application Data
(63) Continuation of application No. PCT/US2007/002901, filed on Feb. 2, 2007.
(60) Provisional application No. 60/764,983, filed on Feb. 3, 2006.

(51) Int. Cl. C40B 40/08; C40B 50/06

(52) U.S. Cl. 506/17; 506/26

(57) ABSTRACT

A process for constructing an artificial coding sequence is provided. The process comprises providing an enzyme adapted to ligate DNA duplexes containing selected codons into multimers that preserve the reading frame of those codons in a reaction facilitated by the presence of a condensing agent, such as polyethylene glycol. These open reading frames may be useful for expressing proteins with a restricted amino acid content.

This application is a continuation application of International Application PCT/US2007/002901, filed Feb. 2, 2007, which claims priority to U.S. Provisional Patent Application No. 60/764,983, filed Feb. 3, 2006, which are hereby incorporated by reference in their entirety.

### TECHNICAL FIELD

The present invention generally relates to methods for making nucleic acid libraries having a limited number of codons and more particularly to methods for making combinatorial nucleotide sequences corresponding to translated proteins with limited amino acid alphabets.

### BACKGROUND

Virtually all proteins in Nature, in every organism from bacteria to humans, are initially expressed as combinations of an identical set of 20 amino acids. The translation machinery assembles the amino acids that comprise proteins by reading a nucleic acid code in units of three bases called codons. Proteins usually begin with a specific codon (ATG, the start codon) and end with another (either TAG, TGA or TAA; the stop codons). The intervening region is called an Open Reading Frame, or ORF. The genetic code describes how that ORF is to be translated into a protein, i.e., it describes the correspondence between codons in the DNA and the amino acids in the final protein. For example, the codon CAG corresponds to glutamine, while CTG corresponds to leucine. The resulting proteins are exquisitely powerful polymers, folding into, for example, highly specific enzymes, selective binding molecules such as antibodies, toxins, or molecular machines. Any strategy that allows novel proteins to be synthesized has the potential to support an array of new enzymes, artificial antibodies, and diagnostics, i.e., molecules that may be used to specifically identify the presence of another molecule. Such diagnostics might be used to detect the presence of foreign cells, specific proteins, infectious agents or small molecules. They could also be used as tools to identify protein surfaces as targets for antibiotics or anticancer drug actions by revealing sites required for function.

Many reviews of the efforts to define a relationship between primary amino acid sequence and folded protein structure include a colorful analogy that illustrates the enormity of sequence variations available to proteins comprising twenty amino acids. For example, one skilled artisan notes that: “Sequence space for even a very small protein (e.g. 50 amino acids or ˜6 kDa) is mind-bogglingly large. One molecule each of the 10⁶⁵ variants would weigh in at 10³⁹ tonnes; approximately the mass of the Milky Way galaxy”. At the same time, most of the amino acids in protein structures may be replaced individually or in blocks with alanine, for example, without grossly distorting the structure or function of the protein except when crucial residues are replaced. So while the protein sequence space is large, it is also highly degenerate.

Various studies have focused on fixed-length proteins built from restricted amino acid sets. For example, Sauer and colleagues built randomized proteins from the amino acids glutamine (Q), leucine (L) and arginine (R) at 50%, 40% and 10%, respectively (QLRa) (Davidson, A. R. & Sauer, R. T. (1994) Proc. Natl. Acad. Sci. USA, 91(6), 2146-50.), and later at 40%, 28% and 18% with 14% of the library made up of linker amino acids (QLRb) (Davidson, A. R. et al. (1995) Nat. Struct. Biol., 2(10), 856-64). These libraries were built using a synthetic oligonucleotide cassette strategy to generate coding sequences either 84 or 107 amino acids long. They report that ˜5% of the library members in QLRa formed stable structures that could be detected in E. coli by western analysis, although none proved to be soluble (Davidson, A. R. & Sauer, R. T. (1994) Proc. Natl. Acad. Sci. USA, 91(6), 2146-50). In QLRb, with a reduced hydrophobic content, they also found that ˜0.5% of the library members were isolated as soluble proteins (Davidson, A. R. et al. (1995) Nat. Struct. Biol., 2(10), 856-64). Characterization of individual proteins by circular dichroism (CD) and thermal melting analyses revealed that many of the proteins were enormously stable (two were stable at 90° C. in 6M guanidinium.HCl), resistant to proteolysis, and most formed stable quaternary structures. Based on CD, they were largely built from helical secondary structure. This work demonstrates that as few as three amino acids with diverse physical properties can support stable proteins with unusual properties of thermal stability, and that modulating library component ratios was able to yield a desired outcome, i.e. generating soluble proteins.

In another illustration of proteins built from a limited amino acid complement, synthetic ORFs built from synthetic oligonucleotides were constructed where restricted codons describe a limited amino acid set (Hecht, M. H. et al. (2004) Protein Sci., 13(7), 1711-23). The degenerate codons NTN (Val, Phe, Ile, Leu, Met; V, F, I, L, M) and (GAC)AN (His, Gln, Asn, Lys, Asp, Glu; H, Q, N, K, D) segregate the input amino acids into polar ((GAC)AN) or non-polar groups (NTN). In simple terms, a pattern of alternating non-polar and polar residues generally gives β-sheet structures, while a pattern that places non-polar residues every three or four residues, such as non-polar/polar/polar/non-polar/non-polar/polar/polar, yields extended amphipathic helices. Within these libraries, soluble proteins are common, as are enzymes with esterase activity or heme binding capability. In fact, 14/30 soluble proteins in one experiment had clear heme binding properties.

Libraries constructed using the general strategies exemplified above are severely limited in power in several ways. First, strategies based on oligonucleotide synthesis result in fixed-length libraries, thereby limiting product length as a variable. Second, they are severely constrained to degenerate regions of the genetic code. The QLR libraries are accessible precisely because the amino acids Q, L and R can be expressed from the degenerate codon C(TAG)G; CTG codes for leucine (L), CAG for glutamine (Q) and CGG for arginine (R). Third, such libraries necessarily exclude amino acids that normally serve to interrupt secondary structure. The GAN/NTN basis set described above, for example, excludes Gly, Ser, and Pro, which are commonly found within reverse turn structure (Creighton, T. E. (1984) Proteins structure and molecular properties, Freeman W. H. and Company, pp. 1-515). Libraries that exclude these residues might therefore be more likely to adopt extended helical or sheet structures, depending on the amino acid content or patterning of hydrophobic and hydrophilic residues.

Several other experimental approaches have demonstrated that stable proteins can be selected from randomized DNA sequences, and that enzymes with restricted amino acid content remain viable. Keefe and Szostak selected ATP-binding aptamers in vitro by directly coupling the protein product to its cognate mRNA and selected for ATP binding capability. Keefe, A. D. & Szostak, J. W. (2001) Nature, 410, 715-18. Using a simplified set of four polar and four non-polar residues, Taylor et al. (Taylor, S. V. et al. (2001) Proc. Natl. Acad. Sci. USA, 98(19), 10596-601) used a modified E. coli host (Kast, P. et al. (1996) Proc. Natl. Acad. Sci. USA, 93(10), 5043-8) to identify active chorismate mutase mutants that contained wholesale structural replacements. Much more striking is the demonstration by Akanuma et al. that the E. coli orotate phosphoribosyltransferase, an enzyme of 213 amino acids, could be described with 13 amino acids (C, H, I, M, N, Q, W were absent). Akanuma, S. et al. (2002) Proc. Natl. Acad. Sci. USA, 99(21), 13549-53.88% of the remaining residues were A, D, G, L, P, R, T, V or Y. However, attempts to explore limited sequence space in a systematic way are severely limited by the inability to control the amino acid content, and these approaches again have been carried out on proteins with an arbitrary open reading frame length.

Many attempts have been made in the art to control the sequence content of DNA libraries, such as those described above. One fundamental problem is that, if one begins with a random DNA sequence to generate protein libraries, the frequency of stop codons is so high as to severely limit the number of long polypeptides that can be made. A second problem is inherent to the diversity of amino acid physical and chemical properties, because individual amino acids often prefer to reside in specific secondary structure, such as alpha helices, beta sheets or reverse turns between secondary structure elements. The ability to form extended secondary structure elements is limited because the frequency of encountering long runs of amino acids with similar secondary structure preference is low.

Therefore, it would be desirable to have a method for the synthesis of combinatorial nucleic acid and protein libraries comprising input codons (and therefore amino acids) selected by the designer. This method may be part of a powerful strategy for dissecting the relationship between primary amino acid sequence and the ability of proteins to form secondary, tertiary and quaternary structure. The resulting novel proteins may be broadly useful, recapitulating structural and functional properties found in naturally occurring proteins, but it is also expected to yield proteins with structural and functional properties not found in native proteins, such as extreme stability or novel enzymatic activity.

### SUMMARY OF THE INVENTION

The present teachings provide methods for constructing artificial open reading frame coding sequences for expressing novel proteins that contain a limited number of amino acids. According to these teachings, codons are selected to control the structural and functional properties of both the genes and the proteins made.

In one aspect of the present invention there is provided a method for constructing an Open Reading Frame (ORF) library comprising open reading frames where the method comprises the steps of selecting desired codons to be included in the open reading frame library, synthesizing DNA duplex n-mers comprising the selected codons and their complements, wherein n is any multiple of three not less than six and ligating together the DNA duplex n-mers to produce open reading frames. The number of input codons is not limited in the approach, but constraining the number yields libraries of ORFs that correspond to proteins with limited alphabets. The method may further comprise the step of adding stop-mers to the DNA duplex n-mers to stop the multimerization reaction of the ligating step. Alternatively, the method may further comprise the step of isolating fractions of the open reading frames from the open reading frame library wherein the fractions comprise different lengths of the open reading frames.

In another aspect of the present invention, at least two open reading frame libraries produced by the method of the present invention may be further ligated together to produce more complex open reading frames.

In a further aspect of the present invention, the open reading frames produced by the method of the present invention may be cloned into an appropriate vector and the proteins coded by the open reading frames may be expressed.

### BRIEF DESCRIPTION OF DRAWINGS

The above-mentioned aspects of the present invention and the manner of obtaining them will become more apparent and the invention itself will be better understood by reference to the following description of the embodiments of the invention taken in conjunction with the accompanying drawings, wherein:

FIG. 1 is a matrix of the available dicodons and their partners in the context of their A/T content, according to the present invention;

FIG. 2a is a scheme depicting a method for producing open reading frame nucleic acids based on repeated blunt-end ligations of dicodons (six-mers), according to the present invention;

FIG. 2b is a scheme depicting a method for capturing dicodon ORFs for cloning using hairpin terminators, according to the present invention;

FIG. 3a is a scheme depicting a method for creating combinatorial nucleic acid libraries from tricodons (nine-mers) where the nucleic acids have a 3′ one-base overhang, according to the present invention;

FIG. 3b is a scheme depicting a method for capturing dicodon ORFs for cloning using non-identical hairpin terminators, according to the present invention;

FIG. 3c is a scheme depicting a method for creating combinatorial nucleic acid libraries from nine-mers where the nucleic acids have a 5′ one-base overhang, according to the present invention;

FIG. 3d is a scheme depicting a method where two classes of tricodons are designed to exclude self-ligation, according to the present invention;

FIG. 4 is a scheme depicting a method for linking libraries of directional ORFs in situ;

FIG. 5 illustrates a method for creating libraries with alternating classes of structure linked by structure-breaking amino acids;

FIG. 6 is a scan of an agarose gel showing the effect of PEG 8000 concentration on blunt-end ligation efficiency of dicodons, according to the present invention;

FIG. 7 is a scan of an agarose gel showing the effect on the length of multimeric product of introducing stem-loop DNA terminators (stop-mers) into the ligation reaction, according to the present invention;

FIG. 8 is a scan of an agarose gel showing the selective precipitation of library products based on nucleic acid length, according to the present invention;

FIG. 9a is a scheme depicting the cloning of library fusions to the lambda DNA binding domain, according to the present invention; and

FIG. 9b is an illustration showing the selection of structure using the library fusions to the lambda DNA binding domain, according to the present invention; and

FIG. 10 is a scan of an agarose gel showing multimeric ligation products digested at dicodon junctions, according to the present invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Broadly, the present invention provides methods for the synthesis of combinatorial libraries of open reading frames (ORFs) comprising selected codons. The methods may be based on multimerizing DNA duplexes by ligation into long multimers that preserve the input reading frame. The multimerizing DNA duplexes (n-mers) may be multiples of three base pairs having a minimum of six base pairs, i.e. n=6, 9, 12, 15, etc. In contrast to previous approaches based on mining libraries of randomized or degenerate sequence space, the methods of the present invention may yield libraries of proteins whose aggregate chemical and physical properties, as well as individual amino acid identities and content, may be modulated. Combinatorial synthesis of ORFs from the codons may exclude redundant sequences, locally constrain patterns of amino acids in the expressed protein, and/or explore sequence length as a variable. Coupled with appropriate selections for protein structure, the methods may support a reductionist, systematic exploration of protein sequence space such as, but not limited to, identifying limited alphabet sequence motifs that support multimerization of the lambda DNA binding domain.

Previous work describing proteins derived from limited sequence space have demonstrated enormous potential for finding proteins rich in secondary structure with native-like properties. However these approaches are highly constrained by factors such as a fixed protein length and the reliance on degenerate codon structure, e.g., using repeated GNN codons to specify a focused subset of amino acids. Binary patterning, or constructing reading frames with hydrophobic and hydrophilic residues situated in selected patterns, adds a powerful layer of selection to identify sequences rich in targeted secondary structure. Nonetheless, it cannot explore sequence space outside the input binary pattern or degenerate codon structure. By contrast, the methods of the present invention may be based on choosing sets of amino acids with compatible structural or chemical properties that allow modulation of the aggregate properties of the library and patterns of amino acids within the library. Amino acids with specific contributions desired in small amounts, such as cysteine as a disulfide bond contributor or histidine as a general acid or base, may be titrated into libraries. Furthermore, building libraries using the methods of the present invention may have two powerful advantages over combinatorial library synthesis using a limited set of expensive codon phosphoramidites. Redundant sequence space, i.e. runs of a single amino acid, may be excluded if desired, and coding sequences may not be limited to the arbitrary length chosen for synthesis. Coupled with a selection for structure or function, protein sequence space may be explored in a far more systematic and focused manner than previously possible.

The methods of the present invention may comprise a combinatorial methodology for the synthesis of open reading frames (ORFs) comprising a small number of selected codons. These ORFs may then be captured and fractionated based on length. In this way, genes that express novel proteins comprising small sets of amino acids, e.g. 3 to 10 but not limited to any specific number, may be expressed and characterized. This contrasts with virtually every naturally occurring protein, which are generally composed of 20 amino acids. One key advantage of the present methods may be their ability to severely limit the number of codons incorporated into a nucleic acid and therefore control both codon and amino acid diversity.

The methods of the present invention for constructing artificial ORFs may comprise the steps of selecting desired codons, synthesizing DNA duplex n-mers comprising the selected codons and their complements and ligating together discrete DNA duplex n-mers. The DNA duplex n-mers may be multiples of three base pairs having a minimum of six base pairs, i.e. n=6, 9, 12, 15, etc. By way of non-limiting example DNA duplexes having multiples of three base pairs may be six-mers (dicodons), nine-mers (tricodons) or twelve-mers (tetracodons). It will be appreciated that in having DNA duplexes with multiples of three base pairs, the open reading frame may be maintained with the ligation of additional DNA duplexes.

In an illustrative embodiment, the DNA duplexes may include a designed set of DNA oligonucleotides six base pairs in length. Guidelines for choosing the starting sequences are disclosed below. Such six-mers may have several powerful advantages for generating libraries over other strategies, including broad flexibility in library design. They may also represent units of two codons, thereby maintaining the reading frame inherent to the starting dicodon. Six-mers may be long enough to produce a substantial fraction of double-stranded DNA in the presence of a complementary strand at temperatures where DNA ligases are highly active. Additionally, building a combinatorial library of sequences requires that a relatively small number of DNA duplexes (dicodons) must be included in the starting material mixture. For example, all possible combinations of any four amino acids can be described by sixteen pairs of DNA molecules (4²=16).

While six base pair (bp) duplexes, or six-mers (dicodons), are used for illustrative purposes, DNA duplex n-mer lengths divisible by three may also maintain the input open reading frame in the ORF products. By way of non-limiting example, inclusion of nine base pair duplexes (nine-mers) may also preserve the input ORF. These nine-mers may have specific advantages for incorporating amino acids expressed from AT-rich codons, such as phenylalanine (TTT) or lysine (AAA), into libraries primarily built from G/C-rich dicodons, or they may be used in conjunction with other nine-mers. However, it should be noted that coverage of possible library combinations requires an exponentially larger number of nine-mers instead of six-mers. Complete coverage of a four amino acid library now requires 64 (4³) input nine-mers. The methods of the present invention may exclude oligonucleotides that disrupt the reading frame inherent to the input codons, i.e. codons whose length are not multiples of 3 base pairs and therefore do not represent integer numbers of codons.

In one embodiment, the libraries of ORFs may be comprised of complementary codon pairs. The codon content of the ORFs that may be constructed by the methods of the present invention may be constrained by the identity of each codon's complementary sequence. Libraries may thus be limited to 26 non-redundant amino acid pairs when codons whose partners specify a translational stop are excluded. Using the standard one-letter code abbreviations for amino acids, the pairings may be: FK, YI, IN, FE, LQ, SR, YV, LK, HM, ID, TS, TC, NV, SG, LE, PR, PW, HV, RT, TG, SA, VD, AC, PG, RA, and AG. When considering the properties of the proteins likely to result from the artificial ORFs described herein, it may be helpful to simply choose combinations of these pairings.

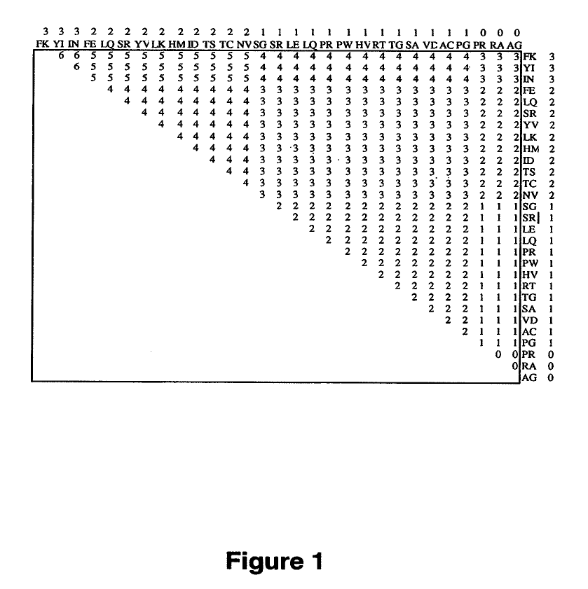

In selecting the codons and amino acid pairings for ORF libraries, it may be advantageous to consider the AT content of the resulting nucleic acids. The matrix presented in FIG. 1 shows amino acid partners linked by complementary codons on each axis and the AT content at the intersection of each pair. Each codon must enter the library accompanied by its complement because each DNA duplex n-mer may be incorporated into a library in either orientation when blunt ended n-mers are used. By way of non-limiting example, to construct a library with ORFs coding for proteins containing the four amino acids M, A, S and H, the complementary codon pair of Ala and Ser, AS (GCT/AGC) plus the additional complementary codon pair Met and His, HM (ATG/CAT), may be used. The average AT content for the dicodons (six-mers) in this library is 3/6, indicated by a ‘3’ at the intersection of SA and HM in the matrix of FIG. 1. While only one n-mer has been encountered that apparently failed to function based on sequencing done to date (AAATTT), which may be due to its high AT content and therefore low predicted melting temperature, highly AT or GC rich ORFs may still present specific problems for library construction or protein expression.

It will also be appreciated that because of the degeneracy of the nucleic acid code, amino acids may be represented by multiple codons. Individual amino acids may have up to five different complements that may be selected. The complementary choices for each of the 20 naturally occurring amino acids are given in Table 1. For example, Leu may enter a library with Gln, Glu or Lys, while Ala can enter with Ser, Cys, Arg or Gly. In selecting the codons and amino acid pairings for ORF libraries, it may also be advantageous to consider the effect specific amino acids may have on protein structure. Table 1 further classifies each amino acid with respect to the frequency of appearance in classes of protein sequence (i.e., α-helix, β-sheet, reverse turn) which may aid in selecting amino acid pairings. The “NEXT” heading in Table 1 identifies the next most likely secondary structure that an amino acid may occur in (Creighton, T. E. (1984) Proteins structure and molecular properties, Freeman W. H. and Company, pp. 1-515). In designing a library that might adopt primarily helical structure, for example, amino acids and complements may be selected using this information. For example, the LARQ and LARE libraries are predicted to generate proteins that adopt predominantly α-helical secondary structure.

TABLE 1
Complementary amino acid partners in a structural context.

| | | Complementary | |
|---|---|---|---|
| | | choices | NEXT |
| APPEARING in | | | |
| α-HELICES | | | |
| ALANINE | A | G, C, R, S | SHEET |
| CYSTEINE | C | A, T | TURN |
| LEUCINE | L | Q, K, E | SHEET |
| METHIONINE | M | H | SHEET |
| GLUTAMATE | E | L, F | TURN |
| GLUTAMINE | Q | L | TURN |
| HISTIDINE | H | M, V | SHEET |
| LYSINE | K | F, L | TURN |
| NEUTRAL | | | |
| ARGININE | R | A, T, P, S | |
| APPEARING IN | | | |
| β-SHEET | | | |
| VALINE | V | D, N, H, Y | HELIX |
| ISOLEUCINE | I | N, D, Y | HELIX |
| PHENYLALANINE | F | K, E | HELIX |
| TYROSINE | Y | I, V | TURN |
| TRYPTOPHAN | W | P | HELIX |
| THREONINE | T | S, C, G, R | TURN |
| APPEARING in | | | |
| TURNS | | | |
| GLYCINE | G | A, T, P, S | SHEET |
| SERINE | S | R, G, A, T | NEUTRAL |
| ASPARTATE | D | V, I | HELIX |
| ASPARAGINE | N | V, I | HELIX |
| PROLINE | P | R, G, W | NONE |

In one embodiment of the present invention, once the desired codons and their complements are selected, the methods may also comprise the step of synthesizing DNA duplex n-mers comprising the selected codons and their complements. Methods for synthesizing the DNA duplex n-mers are well known in the art and well within the ability of the skilled artisan. The methods of the present invention may further comprise the steps of ligating DNA duplex n-mers into longer polymers of nucleic acids that may retain the ORFs of the individual n-mers. The methods comprise repeated ligations of selected n-mers where the n-mers may have blunt ends or one or more base overhangs. The DNA duplex n-mers may be ligated by blunt-end ligation. When blunt end ligation is chosen, then the duplex n-mer may be limited to the selected codons and their complements. Blunt-end ligation may be used with n-mers of any length. Alternatively, the DNA duplex n-mers may be constructed having at least a one base overhang. The number of bases in the overhang may depend on the length of the n-mer and the desired ORF product. Use of an overhang on either the 3′ or 5′ ends of the n-mer allows for more control over the composition of codons within the ORFs because the presence of the overhang may circumvent the requirement that a codon be paired with its complement as with blunt end ligation. As with blunt end ligation, the use of an overhang is not limited by the length of the n-mer. It will be appreciated by the skilled artisan however, that there may be a greater incidence of misalignments in the ORFs with the shorter n-mers such as six-mers. The longer the n-mers, i.e. nine-mers, the more likely the correct overlapping bases may anneal.

The primary constraint on the blunt end ligation approach may be that each codon must enter a library accompanied by its complement. Many amino acid pairings are flexible, based on codon degeneracy, which supports up to four partners per amino acid. Some are more highly constrained, e.g., tryptophan may enter only with proline, although proline may also enter with arginine or glycine. Any amino acid may be placed adjacent to any other in non-palindromic inputs. This may support library construction at the level of pairs of amino acids, constraining and focusing sequence space as amino acid composition is modulated and patterned. The complementary codon constraint may also lead to a leveling of overall library hydropathy, because each hydrophobic amino acid (FLIMV) has as its complement a polar or charged amino acid (EDKRQNY). Within libraries, varying the concentration of palindromes may also serve as levers to raise or lower the representation of two codons at a time. Overall, the methods of the present invention may be highly flexible.

In one embodiment of the present invention the length of the n-mers as well as the number of different codons and amino acids coded for may not be limited by the examples herein. The ORF libraries may comprise entirely palindromic or non-palindromic sequences or a mixture of both. Alternatively, repetitive sequences may be excluded. Libraries may not be limited to sets of twelve six-mers or any other n-mer; additional n-mers may be titrated into libraries, sets of n-mers may be mixed to expand library complexity, and codon representation may be modulated by changing the input ratio of different n-mers. There may also be a mixture of n-mers, for example, six-mers and nine-mers combined. Overall, the method of the present invention may be exceptionally versatile, with general caveats such as that GC-rich libraries present sequencing challenges and AT-rich libraries multimerize less efficiently. The overall fidelity of the process is summarized in the observation that in over 30 kilobases of sequenced ORFs from unselected pools, only a single internal reading frame error has been identified in multimers produced by blunt-end ligations.

In another embodiment, libraries may be synthesized individually and then linked together. For example, MASH and LARQ libraries may be synthesized independently of one another for a desired amount of time and then combined and ligated to one another. The ligation may be a blunt end ligation where no linker is required or a linker to link together the different ORFs may be used. The resulting proteins from the combined libraries may be “two-armed” proteins that may be used to bind to a target using two different strategies producing a higher affinity interaction than either arm alone.

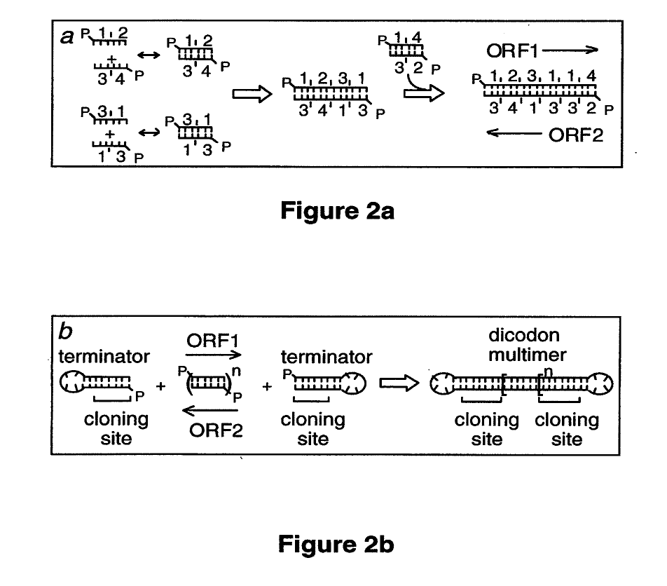

In one exemplary non-limiting embodiment according to the present invention, DNA libraries may be built from a set of four codons. FIG. 2a illustrates the exemplary blunt end ligation of six-mer DNA duplexes comprising combinations of these four codons to be multimerized into long open reading frames (ORFs). The chosen six-mers (dicodons) may be polymerized to give synthetic genes competent to express proteins comprising a limited basis set of the four amino acids. Codons that are poorly utilized in the organism used to express the proteins may be avoided in the experimental design.

Additionally, as illustrated in FIG. 2a, an arbitrary subset of the possible combinations of four codons is presented. Codon 1 may be the complement of codon 3, and similarly codon 2 may pair with codon 4 (reading 5′ to 3′). Libraries may be comprised of both non-palindromic (e.g. 1,2 paired with 3,4) and palindromic (3,1 is self-complementary) dicodons. In this approach codons may enter the library accompanied by their complement and dicodons may be incorporated in the growing DNA chains in either orientation. The product is therefore a long DNA molecule containing a distinct but complementary ORF in each strand comprising an identical small set of codons.

In the exemplary embodiment illustrated in FIG. 2a, the blunt-ended ligations that support multimerization may allow dicodons to enter the growing ORF in either orientation. Each strand therefore contributes a non-identical open reading frame comprising the library components. Amino acids therefore enter the library along with a partner derived from the codon complement (see FIG. 1 and Table 1). For example, in an ORF library that would express proteins containing the four amino acids Leu, Ala, Arg and Gln (LARQ), Leu and Gln are encoded by complementary codons, as are Ala and Arg, when reading each sequence 5′ to 3′. Each possible codon (and therefore amino acid) combination may be constructed from four dicodon pairs and four palindromic dicodons. For example, in FIG. 2a, if Leu=1 and Ala=2, then Gln=3 and Arg=4.

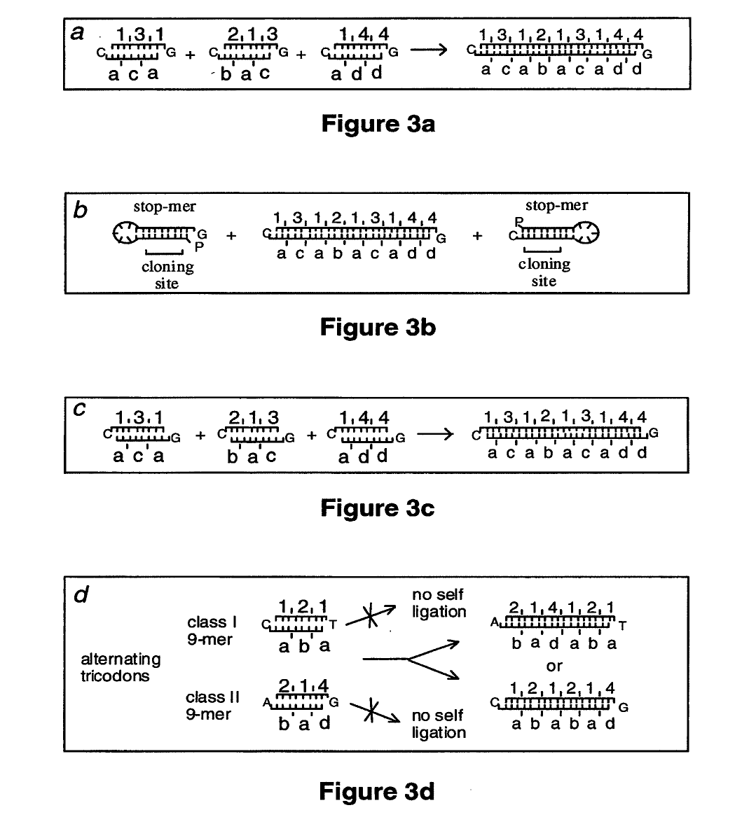

In an alternative exemplary embodiment, the requirement that each codon selected for the targeted library must enter with its complement may be circumvented by simple design modification. Such a strategy is based on multimerizing n-mer DNA duplexes that present a single base overhang on each end (FIGS. 3a and 3c). In FIGS. 3a-d, selected nine-mer (tricodon) DNA duplexes with a single base overhang (8 annealed base pairs) may be used solely to illustrate the process and are not meant to be limiting. The numbers 1-4 may describe four distinct codons for selected amino acids, while the letters a-d in opposite strand may represent their respective complements. The overhang may be either 3′ (FIG. 3a) or 5′ (FIG. 3c). Illustrated in FIG. 3a, strand annealing may create 3′-overhangs of either G or C. Three randomly selected tricodons possibilities (131, 213, 144) may be presented in an arbitrary arrangement. Ligation based on G-C pairing may enforce the synthesis of multimers where all the selected codons end up in one strand. In FIG. 3c, an analogous method is presented where the same tricodons are presented, but may now containing overhangs created on the 5′-end of the duplexes. It will also be appreciated that, although an overhang of 1 nucleotide is the least complex variation, the overhang need not be limited to 1 nucleotide.

Moreover, more amino acid complexity, as well as some control over the patterning of input codons may be introduced by using combinations of overhanging bases that enforce alternating tricodon incorporation into the library (FIG. 3d). Illustrated in FIG. 3d, a third variation may be where two classes of tricodons are utilized that may not self-ligate using Watson-Crick base pairing. Inter-class ligation may create multimers of alternating classes. In all of these examples, judicious choice of the overhangs supports multimerization of, in this non-limiting example, the nine-mers into ORFs that retain the input reading frame in a single strand. It will be appreciated that these are only illustrations. Alternative overhangs (A-T replacing C-G, for example) may be used as the basis for the multimerization reactions, or different numbers of input codons may be used. In general, maintaining purine overhangs in one strand (A and G) and pyrimidine overhangs (C and T) in the other may be advantageous for maintaining the intended reading frame. This strategy allows directional cloning of the combinatorial ligation product (FIG. 3b), and in this way an initiator methionine and termination codon (as well as flanking amino acids) may also be introduced into each individual clone in the library, derived from the hairpin terminators.

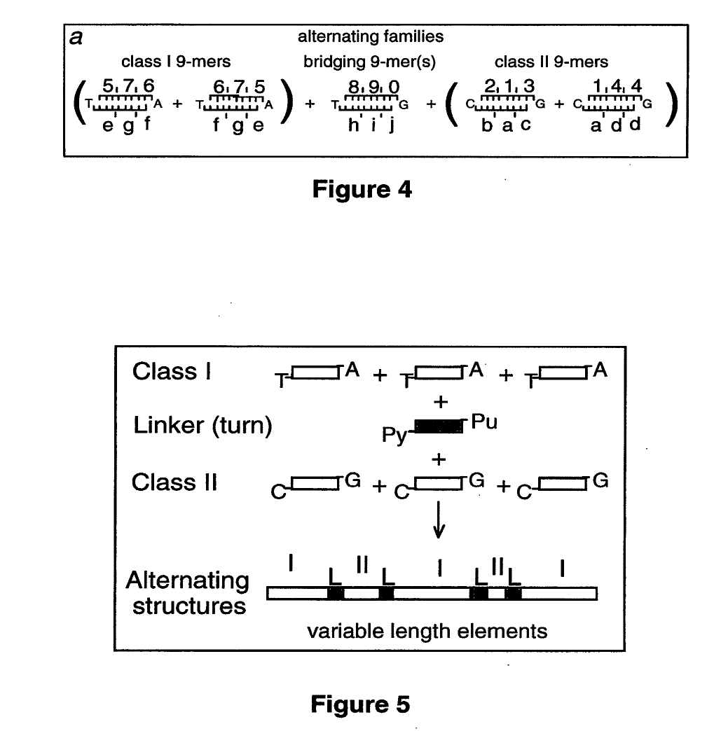

In an alternative exemplary embodiment, nine-mers having a single-base overhang may be ligated together to produce a longer, multimeric ORF, as illustrated in FIGS. 3a and 3c. The use of nine-mers with single base overhangs to maintain reading frame may be expanded to increase the structural complexity of the ORF and corresponding protein products. Moreover, this expansion may have the potential to multimerize classes of dicodons in parallel in a single tube (FIG. 4). In one non-limiting example, shown in FIG. 4, two libraries may be constructed in parallel, one that presents A/T overhangs for one class of tricodons, while the second presents G/C overhangs. This may create two growing sequences that can be linked with a bridging tricodon. The bridge may correspond to amino acids that routinely break secondary structure, such as glycine or proline, but is not limited to those amino acids. The bridging duplex may present two distinct overhangs, each complementary to one of the two tricodon classes, and thus is ligated at the 5′-terminus of one class and the 3′-terminus of the other. In this way, the skilled artisan may produce an ORF that codes for a protein that may link families of amino acids, such as by selecting amino acids that favor α-helical structure in one class and β-sheet structure in the other.

More complex structures may also be accessible by using linker tricodons to alternate classes of structure in longer ORFs (FIG. 5). As a non-limiting example in FIG. 5, Class I sequences may have A/T overhangs, while class II sequences may have G/C overhangs. The linkers (L) may comprise tricodons whose overhangs are either purines or pyrimidines, thus allowing them to bridge the two classes by ligation. In one non-limiting example, linkers that break secondary structure or favor reverse turns may be used to join structural elements that preferentially adopt α-helical or β-sheet structures to yield alternating helical/sheet structures. This may result in ORFs with variable length structural elements that sample each class of amino acid (Class I and II in FIG. 5). The linkers may also be longer sequences, e.g. twelve-mers (four codons) with complementary single-base overhangs that may be used to more precisely recapitulate turn sequences comprising four consecutive amino acids found in model proteins.

In another embodiment of the present invention the DNA duplex n-mers are ligated together to provide multimeric ORFs using procedures well known in the art. For example, selected DNA duplex n-mers may be combined and phosphorylated with a T4 polynucleotide kinase. After phosphorylation, T4 ligase may then efficiently catalyze n-mer polymerization under standard conditions. The reaction temperature for T4 ligase may be from about 12° C. to about 30° C. Lower temperatures may favor annealing of DNA strands to duplex dicodons, while higher temperatures, up to about 37° C., may generally favor improved activity for the T4 ligase. The multimerization reactions may typically be most efficient over a temperature range from about 24° C. to about 28° C., but may also be carried out efficiently at temperatures from about 12° C. to 36° C. The temperature optima may vary slightly with the sequence content of the library, but may be optimized by the skilled artisan without undue experimentation. Polynucleotide kinase and ligase activities from other organisms may also be used, so long as they support the intended multimerization. For example, E. coli ligase could be used in place of T4 ligase when the n-mers present overhangs, but it does not facilitate efficient blunt-end ligation. The methodology is not intended to exclude alternative approaches to creating ORFs non-enzymatically, such as by activating dicodons or tricodons with 5′-phosphates as phosphate ester anhydrides or amides that would support chemical phosphorylation or multimerization in place of the enzymatic reactions.

DNA concentration may be another parameter in the polymerization of n-mers. As is well known in the art, both the kinetics and efficiency of multimerization may be dependent on DNA concentration, with higher concentrations favoring bimolecular reactions. Concentrations of DNA around 90 μM are routinely used for multimerizing n-mers. The reaction may be carried out detectably over a fairly broad concentration range, but multimer yield rapidly becomes limiting at lower concentrations due to poor multimerization efficiency.

The polymerase reaction mixture may also comprise a condensing or crowding agent. Such condensing or crowding agents may aid in generating longer ORFs. Condensing and crowding agents may be agents that sequester the aqueous solvent of the reaction, forcing the n-mers into close proximity to one another and thereby increasing the rate of the reaction and subsequent yield. The condensing agent may be, but not limited to polyethylene glycol. Polyethylene glycol (PEG) may be included in the ligase reaction mixture at a concentration of about 15% to about 25% polyethylene glycol (PEG) at low salt concentrations, although multimers may be formed at concentrations outside this range. Lower PEG concentrations may be advantageous for certain applications such as discouraging long ORF formation. The PEG may have a molecular weight from about 6,000 to about 12,000, although multimers may be formed over a much wider range of PEG lengths, or in the presence of other crowding or dehydrating agents, which may be advantageous for regulating features of the multimerization reaction such as the efficiency or mean product length. In one exemplary embodiment according to the present invention, PEG 8000 may be used as the crowding agent.

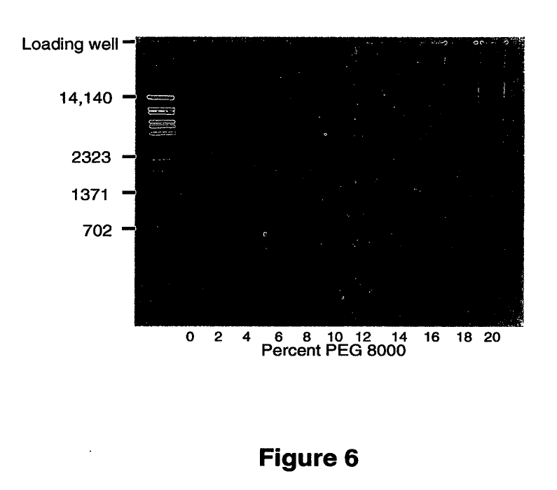

In an exemplary embodiment, a range of PEG 8000 concentrations from about 0% to about 24% percent have been tested, and a significant difference in multimer-forming efficiency is evident depending on the identity of the input n-mers and the reaction temperature. The longest products may be formed at PEG concentrations from 16 to 20%. FIG. 6 shows the length of products that form as a function of PEG 8000 concentration when only non-palindromic dicodons representing the four amino acids leucine, alanine, arginine and glutamine (LARQ) are polymerized. A library of eight dicodons representing combinations of the codons corresponding to Leu, Ala, Arg and Gln (henceforth described as the LARQ library) were polymerized at 24° C. into long products of variable length. The resulting ORFs were analyzed by agarose gel electrophoresis. As seen in FIG. 6, a broad range of molecular sizes is apparent, including a substantial fraction of products longer than 14 kb at higher PEG percentages. At PEG percentages from 0 to 10%, products primarily range up to ˜1 kb in length. Above 10%, most of the dicodons are found in distinctly longer polymers.

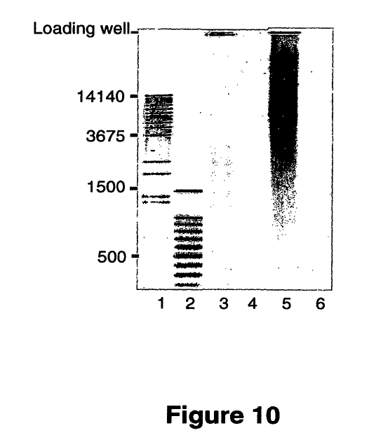

The preservation of the open reading frame in the polymerization products was analyzed. The dicodons CTGCAG (LQ) and CAGCTG (QL) were independently polymerized and these reactions are shown in FIG. 10 (lanes 3 and 5, respectively). In cases where a single dicodon is used, the ORF products may so large that they do not enter a 1.5% agarose gel. In these polymerizations, each blunt ligation is predicted to create a new restriction site at the ligation junction. CTGCAG multimerization creates CAGCTG, which is sensitive to Pst I. CAGCTG multimerization creates CTGCAG, which is sensitive to Pvu II. Digestion of these long products with the endonuclease that recognizes the created junction sequence destroys the multimer to the limits of detection of the system (lanes 4 and 6), while incubation in buffer alone has no effect (lanes 3 and 5). This observation is consistent with the conclusion that the ligation products are long polymers constructed by repeated blunt-end ligations that consume six-mer monomers.

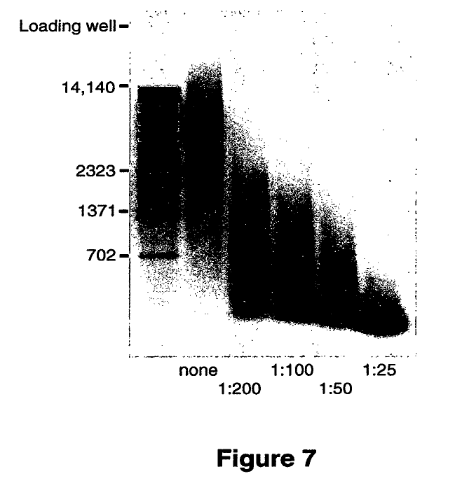

The ORFs produced by the methods of the present invention may serve as templates for expression of proteins comprising a limited set of amino acids from a corresponding limited set of codons. Control over the length of the ORF multimers, and ultimately therefore the product polypeptide, may be achieved by introducing terminator DNA molecules (stop-mers) into the polymerization reactions (refer to FIGS. 2b and 3b). When a stop-mer is ligated to an ORF no additional n-mers may be added and the ORF cannot be extended. As a non-limiting example, the stop-mers may be stem-loop DNA structures that form a hairpin structure, having only one end that can be ligated to the ORFs. However, the chain terminator may be any DNA structure that presents only one end that can be selectively ligated to the growing ORF, such as linear DNA molecules with one non-complementary and non-phosphorylated end, or an one end blocked by virtue of a 3′-dideoxy base and a 5′-non-phosphorylated end. Alternatively, the chain terminator may be replaced with a linear double-stranded DNA molecule competent to ligate on each end that is taken up into growing ORFs. In a simple illustration, the palindromic dicodon CCATGG could be introduced and incorporated internally into a library. The length of ORF between CCATGG sites is predicted to depend on the concentration of this palindrome, and digestion of the multimeric products with the restriction enzyme Nco I, which cuts at the CCATGG, yields variable length ORFs that may be fractionated and cloned. The ligation end of the stop-mers may be blunt ended (FIG. 2b) or have overhanging base pairs (FIG. 3b), depending on the n-mers. Increasing the concentration of stop-mers in the reaction may decrease the length of the products as illustrated in FIG. 7. Polymerization of the MASH library (Met, Ala, Ser and His) was performed in the absence (none) and presence of stop-mer hairpin introduced in the molar ratios given on the x-axis of FIG. 7. Typically, stop-mer inclusion over a range of ratios from 1:200 to 1:15 dicodons, depending on the library under construction, results in a family of lengths of ORFs focused over a size range from a few dicodons to a few thousand bp.

In one embodiment, the stop-mers may comprise restriction sites that allow for the cleavage of the ORF from the hairpin loops. The restriction sites may also allow the ORFs to be cloned into a vector. The restriction sites may be unique to the stop-mers and not found in the ORFs. Moreover the restriction sites may be placed such that cleavage by restriction endonucleases and ligation into an appropriate vector for replication and expression retains the desired open reading frame. In another embodiment, the stop-mers may comprise start and stop codons that are in frame with the ORF and may enable translation of the ORFs to produce the corresponding proteins.

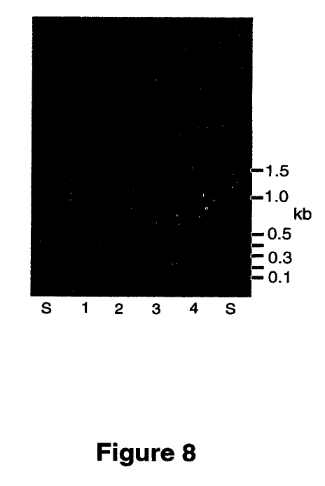

In a further embodiment of the methods of the present invention the ORF products may be isolated and fractionated based on length by precipitation with PEG, as is well known in the art. The PEG may have a molecular weight from about 6,000 to about 12,000, although, as is known in the art, alternative PEG lengths may have advantages for fractionation over selected target lengths. The mixture of ORFs may be adjusted to a higher salt concentration in the presence of PEG and centrifuged to pellet molecules in targeted size ranges. It is well known in the art that PEG precipitation, in the presence of high salt concentration, may be effective for crude sizing of DNA fragments. Surprisingly, fine control over the precipitated DNA length may also be possible (see FIG. 8), where the target length of the ORFs may be adjusted using small changes in the PEG concentration. The precipitation process may be carried out on multi-microgram scale in a matter of a few hours without using labor intensive or scale limiting strategies such as gel purification. Shown in FIG. 8 is a non-limiting example where the LARE library (lane 1), was precipitated into three targeted sizes by sequential treatment with PEG 8000 in the presence of 400 mM NaCl. Each lane (2-4) shows a fraction of the centrifuged pellet using an 8-9% PEG cut (lane 2), a 9-11% cut (lane 3) and an 11-15% cut (lane 4). ‘S’ indicates standard lanes with the lengths given in kb at the right. Still more precise fractionation may be possible with smaller increments of PEG.

Cloning of the synthetic ORFs into expression vectors may be achieved by including the recognition site for an endonuclease (restriction enzyme) into the stop-mer (FIGS. 2b, 3b and 9a). An endonuclease such as, but not limited to, Sal I may allow cloning of library ORF products in-frame, but any enzyme that does not cut in the ORFs may be used. Alternative strategies for cloning may also be effective, such as incorporating a sequence appropriate for recombination, or uracils at specific sites to support ligation-independent cloning strategies. In an exemplary embodiment, characterization of the content of library sequences and verification of ligations that preserve the ORF may be performed by cloning library members into a common cloning plasmid such as pBluescript (Stratagene). Expression of the corresponding proteins may, in principle, be achieved using a wide range of expression plasmids with chosen properties of expression efficiency, fusion tags for affinity purification of products, or other desired parameters. Examples of appropriate plasmids include the pET series, wherein expression can be induced. Expressing proteins as fusions to proteins such as the maltose binding protein, the lambda DNA repressor, or the chitin binding protein may all represent strategies for improving soluble protein expression or simplifying protein purification. The proteins may also be expressed with leader sequences to help protein production as well as protein purification. An example of a leader sequence used in protein purification is a poly-His tag that allows to selective purification using a histidine affinity column.

Advantages and improvements of methods of the present invention are demonstrated in the following examples. The examples are illustrative only and are not intended to limit or preclude other embodiments of the invention.

### EXAMPLES

### Example 1

### LARQ Library

A test library (herein called the non-palindromic LARQ) was designed after the four amino acids it encodes (Table 2a). The library contained eight non-palindromic dicodons with the same G/C content (4/6 bp). Because palindromes were excluded from the input dicodons, it did not initially include the four combinations of AR, RA, LQ or QL. It did describe the eight combinations of LA, LR, QA, QR, RL, RQ, AL, and AQ. However, each possible adjacent amino acid combination can be made at dicodon junctions, including the palindromes. For example, LQ may appear when AL or RL ligates to QA or QR. In short, the libraries represented a diverse but not exhaustive set of dicodons predicted to possess similar annealing properties.

TABLE 2a
Non-palindromic LARQ dicodons.

| | | | |
|---|---|---|---|
| AL | AQ | LA | QA |
| ^{5′}GCGTTG | ^{5′}GCGCAA | ^{5′}TTGGCG | ^{5′}CAAGCG |
| CGCAAC^{5′} | CGCGTT^{5′} | AACCGC^{5′} | GTTCGC^{5′} |
| RQ | RL | QR | LR |

To demonstrate that isolated putative ORFs contained the targeted dicodons, and therefore are capable of expressing proteins containing the designated limited sets of amino acids, 22 clones comprising over 1000 dicodons were cloned and sequenced. The frequencies of dicodon incorporation are given in Table 2b and the frequencies of junction formation in Table 2c. In every case except one the ORF was maintained throughout the clone, where a 2 bp deletion from within one dicodon was observed. For experimental reasons not explained herein, it can be suspected that the deletion occurred within the E. coli host and involved more than two bases, and not by a mis-inclusion of an n-mer duplex into the library.

TABLE 2b
Frequency of LARQ dicodons appearance in open reading frames.

| A L | A Q | L A | Q A | Q R | L R | R Q | R L |
|---|---|---|---|---|---|---|---|
| 163 | 170 | 54 | 147 | 207 | 162 | 40 | 154 |

TABLE 2c
Frequency of appearance of the 16 junctions created by dicodon
ligation.

| | | | | | | | |
|---|---|---|---|---|---|---|---|
| RQ | 176 | LQ | 63 | QQ | 56 | AQ | 53 |
| RL | 54 | LL | 58 | QL | 71 | AL | 27 |
| RA | 16 | LA | 164 | QA | 43 | AA | 101 |
| RR | 117 | LR | 25 | QR | 34 | AR | 13 |

The final tally of amino acids in the arbitrary reading frame chosen for scoring was: Leu (533), Ala (534), Arg (563) and Gln (564). In the complementary reading frame the distribution was Leu (564), Ala (563), Arg (534) and Gln (533); note that the number of Leu codons in the reading frame chosen equaled the number of Gln codons in the complementary strand. This result emphasizes the fact that, on average, the strategy yields an even distribution of the amino acids that comprise it, if not a precise distribution of the combinations. Both strands in the library yielded a novel ORF comprised of the same four amino acids.

### Example 2

### Construction of the MASH Library

The LARQ library above was built around a small set of dicodons whose G/C content is identical and high (4/6 GC). Next, it was determined whether a library built from diverse dicodons with lower GC content would also efficiently polymerize. As such, a library of twelve dicodons was constructed that corresponds to each possible non-redundant combination of the amino acids Met, Ala, Ser and His (the MASH library, Table 3a). Each possible non-redundant amino acid combination is represented, i.e., MS, MA, MH; SM, SA, SH; AM, AS, AH; HM, HS, and HA are each represented equally in the input mix. Individual duplexes in the library present diverse GC-content; the four non-palindromic (NP) pairs have a GC content average of 50% (3/6), while two non-palindromes each with of 2/6 or 4/6 GC pairs are present. Four of the entries are palindromic (P) (GCTAGC, AGCGCT, ATGCAT and CATATG), so that these entries are self-complementary. The dicodons were purified by HPLC (high performance liquid chromatography) by the supplier (GenScript) prior to use. In this library, redundant combinations, i.e., AA, SS, HH and MM were omitted solely for the purpose of limiting overall library redundancy.

TABLE 3a
Construction of the MASH library.

| M S | M A | A M | S M | A S | S A | M H | H M |
|---|---|---|---|---|---|---|---|
| ATGAGC | ATGGCT | GCTATG | AGCATG | GCTAGC | AGCGCT | ATGCAT | CATATG |
| TACTCG | TACCGA | CGATAC | TCGTAC | CGATCG | TCGCGA | TACGTA | GTATAC |
| H A | H S | S H | A H | S A | A S | H M | M H |
| NP- 3/6 | NP- 3/6 | NP- 3/6 | NP- 3/6 | P- 4/6 | P- 4/6 | P- 2/6 | P- 2/6 |

All of the libraries were constructed under similar experimental conditions, illustrated here on large scale using the MASH (Met Ala Ser His) library. The twelve dicodons (Table 1a and 1b) were purified by high performance liquid chromatography by the supplier (GenScript). An equimolar mixture of 7.5 nmol of each input dicodon (90 nmol total) was prepared in 1 mL of a buffer containing 20% (w/v) PEG 8000 (Sigma), 50 mM Tris-HCl (pH 7.5), 10 mM Mg₂Cl, 10 mM DTT, 1 mM ATP, and 25 μg/mL BSA. A stem-loop terminator oligonucleotide (FIG. 1b) comprising the sequence GTCGACTGTTTTCAGTCGAC (0.45 nmol) was included to capture the ORFs for cloning after digestion with the internal Sal I site. All of the reaction components were mixed and kept cool on ice prior to incubations at 37° C. A titration to identify the optimal terminator concentration was performed for each library on small scale prior to library construction. The oligos were phosphorylated with 500 units (50 μL at 10 units/μL) of T4 polynucleotide kinase (New England Biolabs; NEB) by incubation at 37° C. for 1 hour. The reaction was returned to ice for 5 minutes and the multimerization reaction initiated by the addition 20,000 units (50 μL at 400 units/μL) of T4 DNA ligase (NEB) followed by incubation at 24° C. for ˜16 hours. In later experiments, T4 ligase from Takara proved to be superior in the library forming reactions. The longer multimerized products were separated from unreacted dicodons and short products (<˜100 bp) using the High Pure PCR purification kit (Roche) and quantified based on absorption at 260 nm. The recovery of multimeric products from the MASH library was 29.2 μg (19.5%). Libraries with higher GC content give substantially better yields, and the reaction is readily scaled up or down.

As part of the library design, the four dicodons that could lead to repetitive sequence runs were omitted. They were ATGATG/CATCAT (MM or HH, depending on the arbitrarily chosen sense strand) and AGCAGC/GCTGCT (SS/AA). Excluding them from the preliminary analysis was an arbitrary choice to increase the overall non-redundant sequence space explored. The MASH library still generated each of the possible consecutive identical amino acids (e.g., MS ligated to SA gives MSSA). There is no overriding structural or chemical reason to exclude them, although examples of native proteins in Nature where three consecutive identical amino acids are essential for structure or function are rare.

According to one exemplary illustration, 2112 dicodons from 20 clones were sequenced to characterize the incorporation frequency and junction formation preferences in the MASH library (Tables 3b and 3c). In every ORF sequenced, the coding frame was preserved and was built from only the input dicodons (Table 3b). Again, each dicodon was well represented, and the distribution was largely independent of the G/C content of the input dicodons in this case. A chi-squared analysis of the distribution of dicodons in the MASH library leads to rejection of the null hypothesis that each dicodon would appear in the cloned ORFs in an equimolar ratio (p≧0.05%). However, the overall distribution of the four amino acids (M=983; A=1101; S=1078; H=972) does represent an equal distribution of the individual amino acids (p≧0.001% in a chi-squared analysis). This indicates that the overall library is not skewed toward any class of amino acid (hydrophobic vs. polar, for example).

TABLE 3b
Representation of the twelve dicodons in the MASH library (2112
dicodons).

| MS | MA | AM | SM | SA | AS |
|---|---|---|---|---|---|
| 176 | 258 | 177 | 178 | 151 | 155 |
| HA | HS | SH | AH | MH | HM |
| 166 | 155 | 263 | 194 | 118 | 76 |

TABLE 3c
Frequency of appearance of the 16 junctions created by dicodon
ligation in MASH.

| | | | | | | | |
|---|---|---|---|---|---|---|---|
| MM | 107 | AM | 163 | SM | 118 | HM | 154 |
| MA | 105 | AA | 169 | SA | 119 | HA | 136 |
| MS | 126 | AS | 174 | SS | 140 | HS | 147 |
| MH | 77 | AH | 96 | SH | 147 | HH | 113 |

Regarding the diversity within the libraries, it is appropriate to reiterate the material scale and the associated diversity. Beginning with 150 μg of oligo DNA, a MASH variant whose composition is not described here but that represents one of the lower yields recovered, 6 μg were recovered in a fraction whose member sizes ranged from ˜450 to 1000 bp and 1 μg in a fraction whose member sizes ranged from ˜250-450 bp in length. While the larger scale reactions or parallel reactions were not explored, there was no reason to believe that the mass of product was limited. One μg of DNA with a mean length of 300 bp corresponds to 0.5 μmol or 3×10¹³ independent species.

### Example 3

### Construction of the LARE Library

In a reaction analogous to Example 2, twelve unique six-mer oligonucleotides (dicodons) were chosen to represent each possible combination of the four input amino acids (LARE), i.e., LE, LA, LR, AL, AE, AR, EL, EA, ER, RL, RA, and RE. Multimerization in the presence of a terminator oligonucleotide (4.5 nmol) comprising the sequence CGTCGACTGTTTTCAGTCGACG captures the library of ORFs but adds an additional C/G base pair to alter the reading frame of the library. In this way libraries may be made compatible with plasmids designed for protein expression that are not in the reading frame of the synthetic ORF. Recovery of multimeric products using the High Pure PCR purification kit yielded 91.8 μg (61.2%) of library DNA.

### Example 4

### Fractionation Based on Product Length

For each library constructed, ORFs were isolated in three size ranges by sequential PEG precipitation of the polymerization products. By using closely defined concentrations of PEG 8000 and salt, ORFs could be precipitated that range from ˜240 to ˜420 bp (˜80 to 140 amino acids). It was also demonstrated (not shown) that ORFs can be easily focused in a window from ˜120 to 240 bp (40 to 80 amino acids) with a higher percentage of PEG and ORFs in the range of ˜420 to 840 bp (˜140 to 280 amino acids) with a lower cut.

The synthetic ORFs were fractionated by length using a sequential precipitation strategy based on precipitation by PEG 8000. Using ORFs comprising codons corresponding to the amino acids LARE (Example 3), 10 μg (of the total 91.8 μg) of the recovered synthetic LARE ORFs were diluted to a volume of 100 μL in water containing 400 mM NaCl and 8% PEG 8000. The solution was allowed to stand at 22° C. for 2 hours and centrifuged at 14,000 rpm in an Eppendorf 5415C centrifuge for 30 minutes. The supernatant was adjusted with 40% PEG 8000 to bring the concentration to 9% and the reaction incubated 2 hours at room temperature. Centrifugation yielded a pellet containing molecules roughly 350-500 bp in length (FIG. 8). The supernatant was again treated with concentrated PEG 8000 to bring the concentration to 11%, incubated 2 hours at room temperature, and the precipitated material was recovered by centrifugation as above to yield 0.6 μg (9-11% PEG cut) comprising molecules roughly 200-350 bp in length (FIG. 8). The process was repeated a third time to recover a fraction (0.28 μg; 11-15% PEG cut) that was insoluble at 15% PEG. The product molecules ranged from roughly 100-200 bp long. The pellets are resuspended in a small volume of 10 mM Tris.HCl (pH 7.6).

### Example 5

### Cloning and Characterizing the Multimeric Products

The synthetic-ORFs were often capped with a terminator hairpin structure that contains a Sal I digestion site (GTCGAC). Digestion of 0.6 μg of the LARE 9-11% PEG precipitation (from Example 4) was carried out in 100 μL using 120 units of Sal I enzyme (NEB) for 4 hours in the buffer recommended by the supplier. The digested product was purified using the High Pure PCR purification kit was used as recommended by the supplier to remove the small fragments removed from the ends of the molecules. Removal of the hairpin fragments is not essential for successful library cloning, and the library products may also be recovered by re-precipitation using PEG 8000. For the purposes of sequencing, the multimers were ligated to a cloning vector (pBluescript SK+; Stratagene) cut with Sal I and dephosphorylated with Antarctic phosphatase (NEB) as recommended by the supplier. The ligation reaction was transformed into chemically competent XL1Blue cells using standard methods and plated on LB with 80 μg/mL ampicillin and incubated at 37° C. overnight. Plasmids containing a library insert were recovered and sequenced using the BigDye version 3.1 protocol (Applied Biosystems) by the Indiana Molecular Biology Institute. Libraries that were GC-rich, e.g., LARQ and LARE, were more efficiently sequenced in the presence of 3-5% DMSO.

### Example 6

### Expression and Selection of Libraries as Fusions to the Lambda DNA Binding Domain

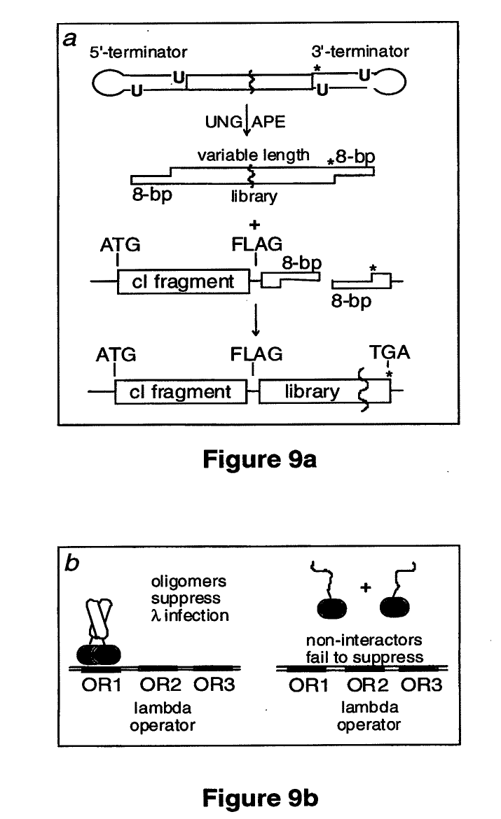

Construction of vector to express fusions to the lambda DNA binding domain. A number of vectors are available to clone ORFs as a fusion to the lambda DNA binding domain in any reading frame. The plasmid pRJ100 was modified to support ligation independent cloning in a manner analogous to the pNEB206A plasmid (NEB), where two non-identical 8-bp overhangs are created to support cloning. The sequence in pRJ100 from the Sal I to Bgl II sites, GTCGACGCCCGGGCATGCTTCGAAGATCT, was replaced with a cassette containing two Bcl I and two Nt.BbvC I nicking sites that incidentally destroy the Bgl II site upon ligation of the cassette using the Sal I and Bgl II sites. The new vector sequence (pRJ100-LIC) reads: GTCGACGGCTGAGGAGACATGATCAGGATCCTGATCACTTTCCCTCAGCG ATCT. The Bcl I enzyme is sensitive to Dam methylation and the plasmid was therefore isolated from E. coli K12 ER2925 cells (NEB). Creation of the 8 bp overhangs was patterned on the USER (uracil specific excision reagent) methodology from NEB. The plasmid (pRJ100-LIC; 10 μg) was digested with 60 units of Bcl I for 4 hrs at 50° C. in a volume of 200 μL, cooled on ice, then treated with 70 units of Nt.BbvC I for 2 hrs at 37° C. The reaction was extracted with phenol and chloroform, precipitated with ethanol, resuspended in 100 μL 10 mM Tris.HCl (pH 7.6) and aliquotted for storage at −20° C. In order to generate compatible 8 bp overhangs, the libraries are captured with two stem-loop terminators containing deoxyuracil (MWG Biotech) with the sequences: TGATGTCTCCUGCTTTTGCAGGAGACAUCA (defines N-terminus of fusion) and TGACTTTCCCUCGTTTTCGAGGGAAAGUCA (defines C-terminus of fusion with a stop codon (TGA). Ligation-independent cloning of the library sequences into the pRJ100-LIC vector was carried out as specified by the manufacturer (NEB) with the exception that the USER reagent (uracil DNA glycosylase and Endonuclease VIII) was reduced to one third of the recommended amount and the reaction was allowed to proceed for 1 hr. Prior to electroporation the DNA was treated with T4 ligase under standard conditions, which improves ligation efficiency up to five fold, then precipitated by bringing the reaction to 0.5M NaCl and 8% PEG 8000. The DNA was recovered by centrifugation at 14,000 rpm in an Eppendorf microfuge, washed with 500 μL of absolute ethanol, air dried and resuspended in a small volume of water.
Isolation and validation of clones. Standard phage plating techniques were used to identify resistant clones from a lawn of cells and lambda phage in top agar. Each library was transformed by electroporation at 2.2 kV (1 mm gap) into competent AG1688 cells, which routinely yielded ≧10⁹ transformants/μg supercoiled DNA and ≧10⁶ transformants/25 ng plasmid DNA and input library prepared using the LIC methodology. All characterized clones were validated by plasmid isolation, re-transformation and challenge against each phage individually in a “line of death” test to confirm sensitivity, followed by challenge to a third phage variant insensitive to receptor function (i^{21c}) by virtue of a mutant operator sequence. Clones of interest were characterized by cycle sequencing using the BigDye v3.1 reagents (Amersham) by the Indiana Molecular Biology Institute.
Selection for self-interacting sequences. The methodology for identification of protein sequences that mediate multimerization of the lambda DNA binding domain is well established. Library transformation by electroporation was followed by a one-hour recovery without selection followed by a three-hour growth under selective pressure (100 μg/ml ampicillin) prior to treatment with the two I phages, λkh54 and λkh54-h80. This increases the redundancy of library components by approximately 100-fold, but in this case a large and variable number of clones failed to emerge from plating in top agar without amplification. This limitation precluded an accurate measurement of the number of lambda resistant colonies in cases where resistance could not be measured directly.
Interacting protein sequences from limited alphabet libraries. In order to characterize the properties of the proteins expressed from the synthetic ORFs, we combined a robust and efficient cloning method with a selection for protein structure. Stem-loop terminators (FIGS. 2b and 3b) were used to support a ligation-independent cloning (LIC) strategy. Deoxyuracil residues were positioned within the duplex region such that base hydrolysis followed by strand cleavage (the USER system, New England Biolabs) yields two non-complementary 5′-overhangs of eight nucleotides, one on each end of a captured clone (FIG. 9a). A vector (pRJ100-LIC) was designed with complementary overhangs that allows efficient directional cloning of library sequences as translational fusions to the lambda repressor DNA binding domain (see FIG. 9b). Such fusions are powerful tools for identifying self and cross-interacting protein sequences competent to reconstitute the lambda repressor activity and allow growth in the presence of the lytic phage. This represents a more conservative approach to structure identification than attempting to recover pseudo-globular structures or proteins with selectable binding or catalytic properties, which are likely to be less common.

The frequency and identity of self-interacting sequences from the MASH, FASK, FARE and LARE libraries was characterized as fusions to the lambda DNA binding domain (Table 9). A broad window of input ORF lengths (roughly 100 to 500 bp) was chosen initially to avoid bias based on an arbitrary input length, which is routinely a constant in alternative strategies. The libraries were transformed into competent E. coli AG1688 cells and challenged with two lambda phage variants (λkh54 and λ54-h80) capable of entering by two distinct routes, a strategy that greatly reduces the number of false positives resulting from receptor mutations. These were rare, and all characterized self-interacting clones were validated by plasmid isolation and re-screening as described above.

TABLE 9
Characterization of the frequency of lambda resistant clones in limited
alphabet libraries.

| | Transformants^{a} | Colonies after | Lambda | Unique^{d} | Library fraction |
|---|---|---|---|---|---|
| DNA | per 25 ng DNA | amplification^{b} | resistant^{c} | sequences | lambda resistant^{e} |
| pRJ100 | 1.5 × 10⁸ | 9.5 × 10⁹ | NA^{f} | NA | NA |
| LIC^{g} vector | 1.2 × 10⁴ | 1.6 × 10⁶ | NA | NA | NA |
| LARE | 3.2 × 10⁶ | 5.9 × 10⁸ | 1.6 × 10⁶ | 16/20 | 6 × 10⁻² |
| FASK | 2.6 × 10⁶ | 3.6 × 10⁸ | 1.1 × 10³ | 15/20 | 4 × 10⁻⁵ |
| FARE | 1.8 × 10⁶ | 1.8 × 10⁸ | 3.1 × 10^{2h,i} | 11/13^{a} | 1 × 10⁻⁵ |
| MASH | 3.6 × 10⁶ | 6.3 × 10⁸ | 2^{h} | 2/2 | 6 × 10⁻⁷ |

^{a}The transformation efficiency for the control vector pRJ100 by electroporation is equivalent to 6 × 10⁹ transformants/μg.
^{b}The transformed population was amplified for three additional hours in the presence of ampicillin following a 1-hour recovery.
^{c}Projected lambda resistant clones from 25 ng of a transformed, amplified library expected if the entire transformed culture were plated.
^{d}Twenty resistant colonies were sequenced to define the redundancy and identify the sequences of self-interactors. In the case of FARE, where 13 sequences are reported, the remainder proved to be a single contaminating clone that was excluded from the analysis. The fraction of self-interactors in the FASK and FARE libraries could not be measured directly and was assessed by comparison with the LARE library. Six percent of unselected LARE clones were lambda resistant in a direct measurement using the line of death (LOD) assay.
^{e}The frequency of lambda resistant clones FARE and FASK was estimated based on their abundance relative to the lambda library in the amplified libraries (column labeled lambda resistant).
^{f}NA = not applicable.
^{g}Ligation independent cloning.
^{h}A single lambda resistant contaminant clone was identified in these libraries and excluded from the analysis.
ⁱThis value is an estimate derived as follows. Of the 480 total lambda resistant FARE clones, 35% (7/20) were determined to be a contaminating clone by sequencing. The total population of FARE was estimated to be 310 colonies, or 0.65% of 480 actual colonies.

The four libraries tested all produced lambda resistant clones with frequencies that varied over five orders of magnitude (Table 9). At the lower extreme is the MASH library, chosen for its balanced GC content (3/6 GC) in the multimerization reaction, which yielded two lambda resistant colonies (a rate of ˜0.6 per million transformants). In sharp contrast is the LARE library, chosen for the ability of its input amino acids to recreate simplified leucine zipper or coiled coil structures, wherein approximately six percent of clones were lambda resistant. Such clones were easily identified by screening individual transformants using the “line of death” assay for phage resistance, which served as a direct measurement for the frequency of resistant clones. Both the FARE (4/6 GC) and FASK (2/6 GC) libraries produced lambda resistant colonies at frequencies that could not be measured directly due to technical limitations of the selection experiment. It was estimated that FASK and FARE produced resistant colonies at a frequency of ˜10 and ˜40 per million transformants, respectively (refer to the legend of Table 9).
Putative interacting sequence motifs. Sequence analysis of some of the lambda resistant colonies, and therefore inferred self-interactors, yielded easily recognizable sequence motifs. The self-interactors from the FASK library, for example, fell into two categories (Table 10; a period at the end of a sequence indicates the C-terminus, while an ellipsis indicates the sequence continues but could not be defined). The most common motif (13/15) placed FFxxFFxzF, (x=A or S; z=A, S or K) precisely at the C-terminus of the fusion with a variable linker (1 to 17 amino acids dominated by A, S and K residues). This sequence motif did not appear in the unselected sequences. While structural determination is beyond the scope of this analysis, it is striking to note that placement of the sequence in an α-helical wheel diagram concentrates the Phe residues on one face of an amphipathic helix. A less frequent motif (2/15) initiates with an alternating AF run of 7 units adjacent to the linker to the lambda DNA binding domain, where S replaced A at one site. In this case the alternating pattern of Phe residues is suggestive of a β-strand structure. In both cases the FASK library offers a striking demonstration on how a restricted alphabet allows detection of consensus hydrophobic regions likely to mediate protein-protein interactions that would be difficult to identify in a 20 amino acid alphabet sequence.

TABLE 10

Fusions to the lambda DNA binding domain that confer lambda resistance.

Clone

| | |
|---|---|
| | FASK |
| 6H | KFFSAFFSAF. |
| 27H | SKAFFAAFFASF. |
| 7H | AKAKAFFSAFFASF. |
| 1H | SKSKAFFSAFFSAF. |
| 24H | AKAKSFFASFFAKF. |
| 4H | KAKAAKAFFASFFSAF. |
| 5H | KAKAKAKAAFFSSFFSKF. |
| 21H | KASFSKSFKAAFFAAFFSSF. |
| 2H | SKFAKSAKAKAFFSAFFSAF. |
| 3H | KAKAKASKAKAKAFFASFFAAF. |
| 28H | SKKAAFAKKAAFKAAFFAAFFASF. |
| 8H | AFKAKSAFAKSKSKAKAFFAAFFSKF. |
| 22H | AFAFAFAFAFSFAFSKSKKASKKAKAKASKKA. |
| 8H | AFAFAFAFAFAFAKAFAK. |
| | MASH |
| 11J | SMSMAMMHMAHSHASHMSAHMAAMAHMAHSAHMAAH. |
| 20J | SMAHAMHAAMMHSMHSAMAHAHMAMAHAMHAHMAMHMSHMMHHMSMMHAHMHMASHMS |
| | FARE |
| 5Y | AREFEFARAREFAREFARFPRFARRFARAR. |
| 12Y* | EFARARAREFAREFAR... |
| 13Y* | ARAREFARARAREFAR... |
| 7Y* | ARAREFARRFAREFARA... |
| 21Y | ARARAREFEFEFAREFARE... |
| 17Y | ARAREFARARAREAAREFARE... |
| 10Y* | AREFEFEFARRFAREFAREFAREFA... |
| 2Y | ARARRAAREFRAARRAEFRAEFEFRAARE... |
| | LARE |
| 15M | ALLRRELRLRREAEALLRLAERLRRLREAE. |
| 9M | EAALLAALLRLRLRLRLAAEEAERLALRLAREAE. |
| 22M | EAALLRLAGLGLGLGLGLGLGLGLGLGLGLGLGLGLGRLREAR. |
| 12M | ARLAALRLERARLALRRERLLAAEERLRREREALRLREAEERERLRARLAERLAARLR. |
| 13M | ARLRLAERLALRLAAEEAALREALREALLRAEERREAELRLAALAEALREALALALLAAELR. |
| 14M | AELAERLRAEARREALLRERLRLRRLLRLAAEALAEAEAERLLRLAAEARLRLAERRLREAE. |
| 2M | EREAREALAEERRLREEAALRLLAARRLALLRLRLRLAEAALAEARLAAEALLAAEERREER. |
| 17M | ERLAALERLRLRRLRLLAARALALAEALLAAERLLAERERLAALERAEARREALREERRERE. |
| 16M | ALLAALREERLAEAGLGLGLGLGLGLGLGLGLGLGLRLGLGLRLGLRLGLGLGLGLGLGLGLGLGREAR. |
| 1M | ALAEALLRLAEALRLAARLAAEERALLAAEALERRLAEAERLEAEAALREALEAARAEALREERARREAE. |
| 11M | ALREARREAEERLRLAERAEALRLRLLRARLRLAERAEARLRLAAEEAEAERALLAERLAEAALLAEAERREALAL |
| | AEARAEERALLAALEAERRE. |

In the MASH, FARE and LARE libraries, where the sequences tended to be longer, prediction of the regions important for self-interaction is more tenuous. However, three striking features are evident that may contribute to competence as self-interactors. First, in the FARE library, the phe residues appear in an alternating pattern in every clone with the exception of a single site in clone (5Y). This may be indicative of structures based on b-strand secondary structure. Second, in the LARE library, two sequences appeared that contain long runs of alternating GL residues, both capped by the same REAR sequence at the C-termini (22M and 16M, Table 10). The GL repeat is conferred by a repeat of GGGCTC (not present among the input dicodons), which is most closely related to the GAGCTC (EL) input dicodon. One can imagine this arising from a cryptic population of GL dicodons present due to a synthetic error and/or by coordinated DNA repair events on the multimeric sequence after introduction into the E. coli host (no extended GL repeats were identified in the host genome). Neither possibility is appealing or satisfactory. Third, in contrast to the unselected sequences, a proline appeared in the FARE library, where TTTCCC (FP) replaced TTTCGC (FA). High-resolution structural information will be required to define the structural significance, if any, of the proline. The appearance of an amino acid with such strong potential effects on secondary structure only in a selected library suggests that its presence may be important to the inferred interaction.

### Example 7

### Product Distribution for ORF Libraries

Product distribution for FASK (Table 7), LARE (Table 8) and FARE were determined. The ORF libraries were synthesized as described for the MASH library in Example 2. Analogous to the MASH library outcome, the sequenced products were composed entirely of in-frame multimers of the input dicodons. FASK represents an AT-rich library and contains two palindromic dicodons composed solely of A and T (e.g., FK=TTTAAA), two that are GC rich (e.g., AS=GCTAGC), and a non-palindromic set of dicodons that contains 2/6 GC bp. The LARE and FARE libraries represent the opposite extreme, with fully GC palindromes such as AR (GCGCGC) and an overall GC content of 4/6 bp (FARE) or 5/6 bp (LARE). As a secondary constraint with respect to the expressed proteins, all libraries tested were built around a strongly hydrophobic residue (M, F or L) and alanine, complemented by a selection of polar and charged residues (S, H, R, E or K).

TABLE 7

Dicodon sequences and inclusion frequencies the
FASK library.

| | | | |
|---|---|---|---|
| F S | F A | A F | S F |
| ^{5′}TTTAGC | ^{5′}TTTGCT | ^{5′}GCTTTT | ^{5′}AGCTTT |
| AAATCG^{5′} | AAACGA^{5′} | CGAAAA^{5′} | TCGAAA^{5′} |
| K A | K S | S K | A K |
| A S | S A | F K | K F |
| ^{5′}GCTAGC | ^{5′}AGCGCT | ^{5′}TTTAAA | ^{5′}AAATTT |
| CGATCG^{5′} | TCGCGA^{5′} | AAATTT^{5′} | TTTAAA^{5′} |
| S A | A S | K F | F K |

| | | | | | |
|---|---|---|---|---|---|
| F S | F A | A F | S F | A S | S A |
| 46 | 62 | 98 | 91 | 231 | 182 |
| A K | S K | K S | K A | E K | K F |
| 110 | 95 | 65 | 39 | 0 | 6 |

| | | | | | | | |
|---|---|---|---|---|---|---|---|
| FF | 17 | AF | 38 | SF | 45 | KF | 5 |
| FA | 62 | AA | 125 | SA | 115 | KA | 43 |
| FS | 57 | AS | 110 | SS | 118 | KS | 27 |
| FK | 45 | AK | 63 | SK | 68 | KK | 24 |

TABLE 8

Dicodon sequences and inclusion frequencies the
LARE library.

| | | | |
|---|---|---|---|
| L R | L A | A L | R L |
| ^{5′}CTCCGC | ^{5′}CTCGCG | ^{5′}GCCCTC | ^{5′}CGCCTC |
| GAGGCG^{5′} | GAGCGC^{5′} | CGCGAG^{5′} | GCGGAG^{5′} |
| E A | E R | R E | A E |
| A R | R A | L E | E L |
| ^{5′}GCGCGC | ^{5′}CGCGCG | ^{5′}CTCGAG | ^{5′}GAGCTC |
| CGCGCG^{5′} | GCGCGC^{5′} | GAGCTC^{5′} | CTCGAG^{5′} |
| R A | A R | E L | L E |

| | | | | | |
|---|---|---|---|---|---|
| L R | L A | A L | R L | A R | R A |
| 119 | 78 | 104 | 74 | 31 | 18 |
| A E | R E | E R | E A | L E | E L |
| 128 | 107 | 114 | 60 | 128 | 105 |

| | | | | | | | |
|---|---|---|---|---|---|---|---|
| LL | 131 | AL | 19 | RL | 132 | EL | 26 |
| LA | 25 | AA | 51 | RA | 29 | EA | 143 |
| LR | 84 | AR | 11 | RR | 71 | ER | 22 |
| LE | 30 | AE | 63 | RE | 22 | EE | 145 |

Because the multimerization reaction is carried out at 24° C. and depends on strand annealing prior to ligation, AT rich duplexes are generally less well incorporated into libraries than GC rich duplexes. This is clear in the FASK library where the FK (TTTAAA) palindrome does not appear in the product ORFs, while the KF palindrome (AAATTT) appears only six times in the data set. Because the multimerization reaction functions over a broad temperature range of at least 12 to 32° C., lowering the reaction temperature may improve the inclusion of such dicodons by increasing the fraction that is in duplex form at the reaction temperature. By contrast, the GC rich (4/6) palindromes AS and SA are overrepresented at 231 and 182 appearances, respectively, where the expected value for each dicodon in an equal distribution of 1025 dicodons is ˜85. An exception to the general increase in dicodon incorporation as a function of GC content is seen in the LARE library (Table 8), where the AR and RA dicodons (31 and 18 occurrences, respectively) are also underrepresented (expected value of 88.8 for 1066 dicodons). These dicodons are the only alternating G/C sequences tested and are model duplexes for Z-DNA conformation, which may explain selection against them. The GC-rich LARE and FARE libraries both presented sequencing challenges, and only in rare cases could FARE ORFs be sequenced from end to end (see Table 10), as runs of AR or RA dicodons caused a rapid decrease in signal intensity.

### Example 8

### Sequence Similarities with Naturally Occurring Proteins

Amino acid sequences with limited sequence diversity have been correlated with disordered regions present in characterized protein structures. Such regions often mediate protein-protein interactions that are relatively weak but highly specific. Individual sequences within the libraries described herein may also possess these properties, so it was asked whether the sequences obtained as self-interactors resembled naturally occurring motifs. To this end the BLAST algorithm for short, nearly identical sequences was used to compare the sequences of the present invention to the non-redundant translated database. With the clear qualification that these data are purely correlative and lack rigorous statistical comparison with unselected or scrambled sequences, it was found that the short, limited alphabet sequences tested resemble sequences residing in translated proteins (Table 11). Perhaps most striking is the cryptic repeating GL sequence found in two LARE clones, which also appears in a human herpes virus protein translation. The FFxxFFxzF motif, if the identities of x and z are modestly relaxed, appears internally in a number of proteins, including as a conserved motif in cytochrome c oxidase subunit III. A naturally occurring in-frame deletion of a five amino acid stretch that includes part of this motif in human mitochondria seriously impairs function. Even the selected MASH sequences can be compared with extended regions in the translated database despite the fact that methionine and histidine are relatively less common amino acids in proteins.

TABLE 6

Alignments of limited amino acid alphabet proteins with naturally
occurring motifs.

| Sequence (library) | | | |
|---|---|---|---|
| (organism) | NCBI locus | (length) | protein name |
| FFSAFFASF. (FASK 7H) | | | |
| FFASFFSSF | BAA29573 | (307) | hypo. Protein (1) |
| FFAEFFAAF | YP_146775 | (247) | hypo. Protein (2) |
| FFAGFFWAF | AP_000645 | (260) | cyt. c oxidase sub. III (3) |
| FFSNFFSSF | NP_615744 | (146) | proteophosphoglycan (4) |
| AFAAFFAAF | YP_293871 | (534) | put. phosphate permease (5) |
| FAFAFAFAFAF (FASK FR1-7) | | | |
| FAFGFAFGFAF | CAL57149 | (220) | NADH-ubiq. Oxidored-rel. (6) |
| FAFAFAFAFVF | XP_740910 | \(59) | hypothetical protein (7) |
| FAFAFAFAF | YP_696081 | \(53) | hypo. protein CPF_1641 (8) |
| FAFAFAFYFA | NP_959134 | (161) | hypothetical protein (9) |
| GLGLGEGLGLGLGLGLGLGLGLGLGLGLG (LARE 22M) | | | |
| GLGLGEGLGLGLGLGLGLGLGLGLGLGLG | CAA52028 | (143) | unnamed protein (10) |
| LGLGLGLGLGLGLGLGLGLGLGEGLG | ZP_00921361 | (630) | Formate hydrogenlyase (11) |
| LTLGLGLGLGLGLGLGLGLDLGLDLGLG | YP_560854 | \(90) | hypo. protein Bxe_A0129 (12) |
| LRRELRLRREAEALLRLAERLRRLREAE (LARE 15M) | | | |
| RLRREAEE----AERLRKLKEQE | NP_660236 | (392) | TraI-like protein (13) |
| RLRREAEE----AERLRKLKEQE | NP_858101 | (404) | TraF/VirB10-like prot. (13) |

(1) Pyrococcus horikoshii OT3;
(2) Geobacillus kaustophilus;
(3) Homo sapiens;
(4) Methanosarcina acetivorans C2A;
(5) Emiliania huxleyi virus 86;
(6) Ostreococcus tauri;
(7) Plasmodium chabaudi chabaudi;
(8) Clostridium perfringens;
(9) Mycobacterium avium;
(10) Human herpesvirus 6;
(11) Shigella dysenteriae 1012;
(12) Burkholderia xenovorans LB400;
(13) Haemophilus influenzae.

### Example 9

### Construction of the LAKE Library where the Input Tricodons All Reside in a Single Coding Strand

A library of eight oligo 9-mers (tricodons) were designed such that the intended coding strand always ended with a 3′-G overhang. These are presented in Table 4 below. The non-coding strand is designed to have a 3′-C overhang in each case, as described in FIG. 3a. The coding strand contains four distinct combinations of the four amino acids leucine (L), alanine (A), lysine (K) and glutamate (E), as shown in Table 4. The tricodons were polymerized using conditions that closely paralleled those presented in Example 2, Construction of the MASH library. However, the concentration of PEG 8000 for this multimerization was 12%. Two hairpin terminators were included instead of one. These contained the same sequence as that presented in Example 2, except that one had an additional 3′-G and the other an additional 3° C. Each is appropriate for the capture of one end of the growing polymer (FIG. 7a). The products were fractionated into products whose length ranged from approximately 100 to 500 bp, as described in Example 4 above. The products were cloned and sequenced as described in Example 5. The distribution of each tricodon in the characterized ORFs is given in the bottom line in Table 4.

TABLE 4

Identity of LAKE tricodons with 3′ overhangs
and their frequency of incorporation into a
multimeric library.

| | | | |
|---|---|---|---|
| A K L | L K A | A E L | L E A |
| GCAAAGCTG | TTGAAGGCG | GCTGAACTG | CTAGAAGCG |
| CCGTTTCGA | CAACTTCCG | CCGACTTGA | CGATCTTCG |
| 119 | 96 | 81 | 94 |

The tricodon tallies presented in Table 4 were derived from four classes of cloning events. 27 ORFs were scored for the presence of these four tricodons. In 21/27 ORFs with a mean length of ˜15 tricodons (135 bp), the multimerization reaction preserved the intended reading frame. In 2/27 ORFs (with a mean length of 19 tricodons) we could not sequence the entire ORF, but the LAKE ORF held true through the entire sequenced region. In 2/27 ORFs, the LAKE reading frame held true, but one of the two cloned ends was incorrect. In 2/27 ORFs an inversion occurred along the length, where a mis-ligation event inverted the reading frame such that part of the sequence read as LAKE tricodons and the remainder read as the complementary sequence. Thus >77% (21/27) of the ORFs represented precisely the intended input coding frame and cloning sequences, while >92% of the ORFs (25/27) were apparently multimerized with the intended coding frame.

### Example 10

### Construction of the LAVTEK Library by Linking Two Classes of Tricodons

Two libraries, each comprising a set of eight input 9-mers (tricodons) were designed such that two classes of four amino acids are encoded. In class I (refer to FIG. 4), the tricodons correspond to an equimolar input ratio of the amino acid sets VKV, VEV, TVK and KVT (Table 5). Each DNA duplex presents a 3′ A or T overhang to allow intra-class multimerization. In class two, the tricodons correspond to the amino acid sets AKL, LKA, AEL, and LEA, where each DNA duplex presents a 3′ G or C overhang. A bridging tricodon that corresponds to the consecutive amino acids SPG was included, where the coding strand presents a single base 3′-G extension and the non-coding strand a single base 3′-T extension. The G-extension is competent to ligate to LAKE library members while the T-extension may ligate to the VTEK library. In this example, the resulting products are of variable length. The tricodons were polymerized using conditions that closely paralleled those presented in Example 2, Construction of the MASH library. Two hairpin terminators were included such that each is appropriate for the capture of one end of the growing polymer (see FIG. 4 and FIG. 7b). The products are fractionated into products whose length range from approximately 100 to 500 bp, as described in Example 4 above. The identity and distribution of each tricodon in the characterized ORFs is given in Table 5. Each cloned ORF contains an in-frame assembly of VTEK tricodons (0 to 57 tricodons) followed by the SPG linker and the LAKE tricodons (0-84 tricodons). The median tricodon length was ˜15 units in each arm. As expected using an equimolar input ratio, a fraction of the sequences either began or ended with the SPG linker, i.e., the stem-loop terminator captured the linker on one end.

TABLE 5

The tricodon frequency present in the cloned in
the LAVTEK library.

| | | |
|---|---|---|
| Class I | linker | Class II |

| | | | | | | | | |
|---|---|---|---|---|---|---|---|---|
| VKV | VEV | TVK | KVT | SPG | AKL | LKA | AEL | LEA |
| 128 | 101 | 71 | 126 | 51 | 68 | 129 | 109 | 112 |

### Example 11

### Construction of the VTEK Library, Analogous to LAKE, but where the Single Base Overhangs form A/T Pairs

A library of eight oligo 9-mers (tricodons) were designed such that the intended coding strand presents a 3′-A overhang and the non-coding strand presents a 3′-T overhang in each case. These are presented in Table 6 below. The coding strand contains four distinct combinations of the four amino acids valine (V), threonine (T), lysine (K) and glutamate (E). The tricodons were polymerized using conditions that closely paralleled those presented in Example 6 (the LAKE library), except that 20% PEG 8000 was used. The two hairpin terminators used to capture the multimers are analogous to those presented in Example 2, except that one had an additional 3′-A and the other an additional 3′T. Each is appropriate for the capture of one end of the growing polymer. The multimers were fractionated into targeted lengths that ranged from approximately 100 to 500 bp, as described in Example 4 above. The products were cloned and sequenced as described in Example 5. The distribution of each tricodon in the characterized ORFs is given in the bottom line in Table 6.

TABLE 6

Identity of VTEK tricodons with 3′ A/T
overhangs and their frequency of incorporation
into a multimeric library.

| | | | |
|---|---|---|---|
| V K V | V E V | T V K | K V T |
| GTCAAGGTA | GTAGAGGTA | ACGGTCAAA | AAGGTGACA |
| TCAGTTCCA | TCATCTCCA | TTGCCAGTT | TTTCCACTG |
| 115 | 106 | 66 | 135 |

While an exemplary embodiment incorporating the principles of the present invention has been disclosed herein above, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for constructing an Open Reading Frame library comprising open reading frames, the method comprising the steps of:
selecting desired codons to be included in the open reading frame library;
synthesizing DNA duplex n-mers comprising the selected codons and their complements, wherein n is any multiple of three not less than six; and
ligating together the DNA duplex n-mers to produce open reading frames.

2. The method of claim 1, wherein at least two open reading frame libraries produced are further ligated together to produce a new open reading frame library.

3. The method of claim 1, further comprising the step of adding stop-mers to the DNA duplex n-mers to stop the ligating step.

4. The method of claim 3, wherein the stop-mers have a hairpin structure.

5. The method of claim 2, further comprising the step of isolating fractions of the open reading frames from the open reading frame library wherein the fractions comprise different lengths of the open reading frames.

6. The method of claim 5, wherein the fractions are isolated by PEG precipitation and wherein the fractions comprise open reading frames having lengths of about 350-500 base pairs, about 200-350 base pairs or about 100-200 base pairs.

7. The method of claim 1, further comprising the steps of:
cloning the open reading frames into vectors; and
expressing the open reading frames to provide the proteins coded by the open reading frames.

8. The method of claim 1, wherein the DNA duplex n-mers comprise blunt ends.

9. The method of claim 1, wherein the DNA duplex n-mers comprise at least a one-base overhang at either the 3′ or 5′ end.

10. An open reading frame library produced by the method of claim 1.

11. The method of claim 1, wherein n is six, nine, twelve or combinations thereof.

12. The method of claim 1, wherein n is six and the n-mers code for four amino acids.

13. The method of claim 12, wherein the n-mers code for the amino acids:
methionine, alanine, serine and histidine;
leucine, alanine, arginine and glutamine; or
leucine, alanine, arginine and glutamic acid.

14. The method of claim 9, wherein an n-mer does not self-ligate.

15. Proteins produced by the method of claim 7.

16. A method of providing proteins coded for by an Open Reading Frame library comprising open reading frames, the method comprising the steps of:
selecting desired codons to be included in the open reading frame library;
synthesizing DNA duplex n-mers comprising the selected codons and their complements, wherein n is any multiple of three not less than six;
ligating together the DNA duplex n-mers to produce open reading frames of the open reading frame library;
cloning the open reading frames into vectors; and
expressing the open reading frames to provide the proteins coded by the open reading frames.

17. The method of claim 16, wherein at least two open reading frame libraries produced are further ligated together to produce a new open reading frame library before cloning the open reading frames into vectors.

18. The method of claim 16, wherein n is six, nine, twelve or combinations thereof.

19. The method of claim 16, wherein the open reading frame is cloned into the vector in any orientation.

20. An Open Reading Frame library comprising open reading frames, wherein the open reading frame library is constructed by:
selecting desired codons to be included in the open reading frame library;
synthesizing DNA duplex n-mers comprising the selected codons and their complements, wherein n is any multiple of three not less than six; and
ligating together the DNA duplex n-mers to produce open reading frames.


SEQUENCE LISTING (68 sequences)

SEQ ID NO: 1 - DNA, 20 bp, Artificial sequence
  Chemically synthesized stem loop termination sequence
gtcgactgttttcagtcgac

SEQ ID NO: 2 - protein, 4 aa, Artificial sequence
  Chemically synthesized example from MASH library where there are consecutive identical amino acids
MSSA

SEQ ID NO: 3 - DNA, 22 bp, Artificial sequence
  Chemically synthesized stem loop termination sequence
cgtcgactgttttcagtcgacg

SEQ ID NO: 4 - DNA, 29 bp, Artificial sequence
  Chemically synthesized pRJ100 sequence between Sal I and Bgl II sites
gtcgacgcccgggcatgcttcgaagatct

SEQ ID NO: 5 - DNA, 54 bp, Artificial sequence
  Chemically synthesized vector sequence for pRJ100-LIC
gtcgacggctgaggagacatgatcaggatcctgatcactttccctcagcgatct

SEQ ID NO: 6 - DNA, 30 bp, Artificial sequence
  Chemically synthesized stem loop terminator
tgatgtctccngcttttgcaggagacanca

SEQ ID NO: 7 - DNA, 30 bp, Artificial sequence
  Chemically synthesized stem loop terminator
tgactttcccncgttttcgagggaaagnca

SEQ ID NO: 8 - protein, 9 aa, Artificial sequence
  Chemically synthesized common motif of the FASK library
FFXXFFXXF

SEQ ID NO: 9 - protein, 10 aa, Artificial sequence
  Chemically synthesized FASK library motif
KFFSAFFSAF

SEQ ID NO: 10 - protein, 12 aa, Artificial sequence
  Chemically synthesized FASK library motif
SKAFFAAFFASF

SEQ ID NO: 11 - protein, 14 aa, Artificial sequence
  Chemically synthesized FASK library motif
AKAKAFFSAFFASF

SEQ ID NO: 12 - protein, 14 aa, Artificial sequence
  Chemically synthesized FASK library motif
SKSKAFFSAFFSAF

SEQ ID NO: 13 - protein, 14 aa, Artificial sequence
  Chemically synthesized FASK library motif
AKAKSFFASFFAKF

SEQ ID NO: 14 - protein, 16 aa, Artificial sequence
  Chemically synthesized FASK library motif
KAKAAKAFFASFFSAF

SEQ ID NO: 15 - protein, 18 aa, Artificial sequence
  Chemically synthesized FASK library motif
KAKAKAKAAFFSSFFSKF

SEQ ID NO: 16 - protein, 20 aa, Artificial sequence
  Chemically synthesized FASK library motif
KASFSKSFKAAFFAAFFSSF

SEQ ID NO: 17 - protein, 20 aa, Artificial sequence
  Chemically synthesized FASK library motif
SKFAKSAKAKAFFSAFFSAF

SEQ ID NO: 18 - protein, 22 aa, Artificial sequence
  Chemically synthesized FASK library motif
KAKAKASKAKAKAFFASFFAAF

SEQ ID NO: 19 - protein, 24 aa, Artificial sequence
  Chemically synthesized FASK library motif
SKKAAFAKKAAFKAAFFAAFFASF

SEQ ID NO: 20 - protein, 26 aa, Artificial sequence
  Chemically synthesized FASK library motif
AFKAKSAFAKSKSKAKAFFAAFFSKF

SEQ ID NO: 21 - protein, 32 aa, Artificial sequence
  Chemically synthesized FASK library motif
AFAFAFAFAFSFAFSKSKKASKKAKAKASKKA

SEQ ID NO: 22 - protein, 18 aa, Artificial sequence
  Chemically synthesized FASK library motif
AFAFAFAFAFAFAKAFAK

SEQ ID NO: 23 - protein, 36 aa, Artificial sequence
  Chemically synthesized MASH library motif
SMSMAMMHMAHSHASHMSAHMAAMAHMAHSAHMAAH

SEQ ID NO: 24 - protein, 58 aa, Artificial sequence
  Chemically synthesized MASH library motif
SMAHAMHAAMMHSMHSAMAHAHMAMAHAMHAHMAMHMSHMMHHMSMMHAHMHMASHMS

SEQ ID NO: 25 - protein, 30 aa, Artificial sequence
  Chemically synthesized FARE library motif
AREFEFARAREFAREFARFPRFARRFARAR

SEQ ID NO: 26 - protein, 16 aa, Artificial sequence
  Chemically synthesized FARE library motif
EFARARAREFAREFAR

SEQ ID NO: 27 - protein, 16 aa, Artificial sequence
  Chemically synthesized FARE library motif
ARAREFARARAREFAR

SEQ ID NO: 28 - protein, 17 aa, Artificial sequence
  Chemically synthesized FARE library motif
ARAREFARRFAREFARA

SEQ ID NO: 29 - protein, 19 aa, Artificial sequence
  Chemically synthesized FARE library motif
ARARAREFEFEFAREFARE

SEQ ID NO: 30 - protein, 21 aa, Artificial sequence
  Chemically synthesized FARE library motif
ARAREFARARAREAAREFARE

SEQ ID NO: 31 - protein, 25 aa, Artificial sequence
  Chemically synthesized FARE library motif
AREFEFEFARRFAREFAREFAREFA

SEQ ID NO: 32 - protein, 29 aa, Artificial sequence
  Chemically synthesized FARE library motif
ARARRAAREFRAARRAEFRAEFEFRAARE

SEQ ID NO: 33 - protein, 30 aa, Artificial sequence
  Chemically synthesized LARE library motif
ALLRRELRLRREAEALLRLAERLRRLREAE

SEQ ID NO: 34 - protein, 34 aa, Artificial sequence
  Chemically synthesized LARE library motif
EAALLAALLRLRLRLRLAAEEAERLALRLAREAE

SEQ ID NO: 35 - protein, 43 aa, Artificial sequence
  Chemically synthesized LARE library motif
EAALLRLAGLGLGLGLGLGLGLGLGLGLGLGLGLGLGRLREAR

SEQ ID NO: 36 - protein, 58 aa, Artificial sequence
  Chemically synthesized LARE library motif
ARLAALRLERARLALRRERLLAAEERLRREREALRLREAEERERLRARLAERLAARLR

SEQ ID NO: 37 - protein, 60 aa, Artificial sequence
  Chemically synthesized LARE library motif
ARLRLAERLALRLAAEEAALREALREALLRAEERREAELRLAALAEALREALALLAAELR

SEQ ID NO: 38 - protein, 62 aa, Artificial sequence
  Chemically synthesized LARE library motif
AELAERLRAEARREALLRERLRLRRLLRLAAEALAEAEAERLLRLAAEARLRLAERRLREAE

SEQ ID NO: 39 - protein, 62 aa, Artificial sequence
  Chemically synthesized LARE library motif
EREAREALAEERRLREEAALRLLAARRLALLRLRLRLAEAALAEARLAAEALLAAEERREER

SEQ ID NO: 40 - protein, 62 aa, Artificial sequence
  Chemically synthesized LARE library motif
ERLAALERLRLRRLRLLAARALALAEALLAAERLLAERERLAALERAEARREALREERRERE

SEQ ID NO: 41 - protein, 69 aa, Artificial sequence
  Chemically synthesized LARE library motif
ALLAALREERLAEAGLGLGLGLGLGLGLGLGLGLGLRLGLGLRLGLRLGLGLGLGLGLGLGLGLGREAR

SEQ ID NO: 42 - protein, 70 aa, Artificial sequence
  Chemically synthesized LARE library motif
ALAEALLRLAEALRLAARLAAEERALLAAEALERRLAEAERLEAEAALREALEAARAEALREERARREAE

SEQ ID NO: 43 - protein, 96 aa, Artificial sequence
  Chemically synthesized LARE library motif
ALREARREAEERLRLAERAEALRLRLLRARLRLAERAEARLRLAAEEAEAERALLAERLAEAALLAEAERREALALAEARAEERALLAALEAERRE

SEQ ID NO: 44 - protein, 9 aa, Artificial sequence
  Chemically synthesized FASK library motif
FFSAFFASF

SEQ ID NO: 45 - protein, 9 aa, Pyrococcus horikoshii
FFASFFSSF

SEQ ID NO: 46 - protein, 9 aa, Geobacillus kaustophilus
FFAEFFAAF

SEQ ID NO: 47 - protein, 9 aa, Homo sapiens
FFAGFFWAF

SEQ ID NO: 48 - protein, 9 aa, Methanosarcina acetivorans
FFSNFFSSF

SEQ ID NO: 49 - protein, 9 aa, Emiliania huxleyi
AFAAFFAAF

SEQ ID NO: 50 - protein, 11 aa, Artificial sequence
  Chemically synthesized FASK library motif
FAFAFAFAFAF

SEQ ID NO: 51 - protein, 11 aa, Ostreococcus tauri
FAFGFAFGFAF

SEQ ID NO: 52 - protein, 11 aa, Plasmodium chabaudi
FAFAFAFAFVF

SEQ ID NO: 53 - protein, 9 aa, Clostridium perfringens
FAFAFAFAF

SEQ ID NO: 54 - protein, 10 aa, Mycobacterium avium
FAFAFAFYFA

SEQ ID NO: 55 - protein, 29 aa, Artificial sequence
  Chemically synthesized LARE library motif
GLGLGLGLGLGLGLGLGLGLGLGLGLGLG

SEQ ID NO: 56 - protein, 29 aa, Human herpesvirus 6
GLGLGLGLGLGLGLGLGLGLGLGLGLGLG

SEQ ID NO: 57 - protein, 26 aa, Shigella dysenteriae
LGLGLGLGLGLGLGLGLGLGLGLGLG

SEQ ID NO: 58 - protein, 28 aa, Burkholderia sp. LB400
LTLGLGLGLGLGLGLGLGLDLGLDLGLG

SEQ ID NO: 59 - protein, 28 aa, Artificial sequence
  Chemically synthesized LARE sequence motif
LRRELRLRREAEALLRLAERLRRLREAE

SEQ ID NO: 60 - protein, 19 aa, Haemophilus influenzae
  NON_CONS (8)..(9)
RLRREAEEAERLRKLKEQE

SEQ ID NO: 61 - protein, 4 aa, Artificial sequence
  Chemically synthesized library name
LARQ

SEQ ID NO: 62 - protein, 4 aa, Artificial sequence
  Chemically synthesized library name
LARE

SEQ ID NO: 63 - protein, 4 aa, Artificial sequence
  Chemically synthesized library name
MASH

SEQ ID NO: 64 - protein, 4 aa, Artificial sequence
  Chemically synthesized library name
FASK

SEQ ID NO: 65 - protein, 4 aa, Artificial sequence
  Chemically synthesized library name
FARE

SEQ ID NO: 66 - protein, 4 aa, Artificial sequence
  Chemically synthesized library name
LAKE

SEQ ID NO: 67 - protein, 5 aa, Artificial sequence
  Chemically synthesized library name
VTECH

SEQ ID NO: 68 - protein, 7 aa, Artificial sequence
  Chemically synthesized library name
LAVTECH